(19) United States
(12) Patent Application Publication
(10) Pub. No.: US 2026/0326893 A1
(43) Pub. Date: Oct. 22, 2026

(54) SUPERSONIC JET CURTAINS FOR CONTROL OF MOMENTS AND FORCES ON AIRCRAFT

(71) Applicants: ARIZONA BOARD OF REGENTS ON BEHALF OF THE UNIVERSITY OF ARIZONA, Tucson, AZ (US); CALIFORNIA INSTITUTE OF TECHNOLOGY, Pasadena, CA (US)

(72) Inventors: Israel Wygnanski, Tucson, AZ (US); Lutz Taubert, Tucson, AZ (US); Emilio Graff, Tucson, AZ (US); Morteza Gharib, Pasadena, CA (US)

(21) Appl. No.: 19/486,550

(22) PCT Filed: May 22, 2024
(86) PCT No.: PCT/US2024/030614

§ 371 Date: Nov. 21, 2025

Related U.S. Application Data
(60) Provisional application No. 63/468,219, filed on May 22, 2023.

(51) Int. Cl. B64C 15/14; B64C 39/10; F02K 1/00; G05D 1/49; G05D 109/22

(52) U.S. Cl. CPC B64C 15/14; B64C 39/10; F02K 1/002; G05D 1/49; G05D 2109/22

(57) ABSTRACT

Conventional moving control surfaces on a typical tailless aircraft are replaced with sweeping Jet Actuators (“SJAs”) for Active Flow Control (“AFC”). However, a large quantity of SJAs may be necessary in each array and efficacy of SJAs has only been demonstrated at low speeds (i.e., Mach 0.2 or less). In this disclosure, Supersonic Steady Jets (SSJs) are used as control surface replacements for aircraft. The SSJs are distributed on the aircraft in locations and orientations that take into consideration changing local flow conditions on the surface of the aircraft. In one example, when a single SSJ was used to control the pitch of the aircraft, the single SSJ increased the trimmed lift of the aircraft almost as well as an array of SJAs, while providing better yaw control at a small accompanying rolling moment.

### CROSS-REFERENCE TO RELATED APPLICATIONS

This application claims the benefit of and priority to co-pending U.S. Provisional Patent Application No. 63/468,219, filed on May 22, 2023, entitled Supersonic Jet Curtains for Control of Moments and Forces on Tailless Aircraft.” The entire content of the above-identified priority application is hereby incorporated by reference herein.

### TECHNICAL FIELD

The subject matter disclosed herein is generally directed to the use of jet output over a wing to control moments and forces on aircraft.

### BACKGROUND

Active Flow Control (“AFC”) is used to suppress boundary layer separation and increase the efficiency of lifting surfaces of aircraft. Conventional control is achieved using moveable control surfaces on the aircraft. AFC was initially focused on prevention of separation of the airflow from the wing and lift enhancement to lower the takeoff and landing speeds of conventional tube and wing airplanes. However, as flight speeds increased and aircraft evolved into tailless aircraft, the focus of AFC shifted toward stability and control, because tailless aircraft configurations lacked the “long-arm” of an aircraft tail to control moments and forces around two of the three axes of rotation (i.e., pitch and yaw). The control problem increased on stealth-type blended-wing-body (“BWB”) configurations without vertical stabilizers and design options that remove conventional moveable control surfaces.

Because of the removal of the empennage, the aircraft needs another means to control yaw and pitch. Conventional systems for yaw control in a tailless aircraft include at least two options. A first option for yaw control is by means of aerodynamic control surfaces placed on the wings of the aircraft. The aircraft is controlled in yaw by differential drag between the two wings of the aircraft. A second option for yaw and pitch control comprises fitting the aircraft with multiple nozzles and controlling the aircraft via the forces created by the jets emanating from these nozzles.

One example of control nozzles is an array of Sweeping Jet Actuators (“SJAs”). SJAs can be used for AFC by generating a sweeping motion of a small jet to reduce separation and to control the path of the leading-edge vortex over the wing to thereby control pitch. An SJA is a small actuator device, often referred to as fluidic oscillator, that emits spatially oscillating jets without moving parts. Proper spacing between each of the SJAs is needed to maintain attached flow over the surfaces of the aircraft. Accordingly, for effective control and separation reduction, a large quantity of SJAs may be necessary in each array. Additionally, efficacy of SJAs was only demonstrated at low speeds (i.e., Mach 0.2 or less).

Both options for providing yaw and pitch control for an aircraft have negative effects in terms of control effectiveness and engine performance. The use of aerodynamic control surfaces requires high maintenance and eliminates stealth. Steering thrust from SJAs does not enable yaw moments and forces of sufficient magnitude to be obtained, and a large number of SJAs are needed to effect sufficient control, leading to heavy and bulky additions to the aircraft. A major difference between yaw control and pitch control is that pitch control (usually) has to be applied throughout the entire flight envelope, whereas yaw control has to be applied only for short duration whenever the direction of flight has to be changed. This difference results in entirely different requirements for the driving systems: ideally low continuous power consumption for pitch control vs. short (strong) bursts for yaw control.

### SUMMARY

Described in certain example embodiments herein are systems to control moments and forces on aircraft as shown and described herein.

Described in certain example embodiments herein are methods to control moments and forces on aircraft as shown and described herein.

Described in certain example embodiments herein are flight control systems to control moments and forces on aircraft as shown and described herein.

Described in certain example embodiments herein are systems to control moments and forces on aircraft, comprising a wing comprising a leading edge; and at least one supersonic steady jet (SSJ) disposed on an upper surface of the wing, the SSJ being oriented such that a jet output from the SSJ is angled with respect to the leading edge of the wing.

In certain example embodiments, the jet output from the SSJ is angled within a range of about 0 degrees to about 180 degrees with respect to the leading edge of the wing depending on the wing's incidence.

In certain example embodiments, the jet output from the SSJ is angled within a range of about 20 degrees to about 160 degrees with respect to the leading edge of the wing depending on the wing's incidence.

In certain example embodiments, the jet output from the SSJ is angled within a range of about 30 degrees to about 135 degrees with respect to the leading edge of the wing depending on the wing's incidence. In some embodiments, the jet output from the SSJ is angled at 30, to/or 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135 degrees with respect to the leading edge of the wing.

In certain example embodiments, the jet output from the SSJ is angled 45 degrees with respect to the leading edge of the wing.

In certain example embodiments, the jet output from the SSJ is angled 45 degrees with respect to the leading edge of the wing on an inboard side of the wing for swept-back wings and or on an outboard side of the wing for swept-forward wings. In certain example embodiments, the at least one SSJ comprises a single SSJ. In certain example embodiments, the at least one SSJ comprises a plurality of SSJs. In some embodiments the plurality of SSJs includes one or more pairs of SSJs. In some embodiments, the plurality of SSJs includes 1, 2, 3, 4, 5, 6, or more SSJs.

In certain example embodiments, the at least one SSJ comprises a plurality of SSJs and all the SSJs are activated to provide a desired control of the aircraft.

In certain example embodiments, the at least one SSJ comprises a plurality of SSJs and less than all the SSJs are activated to provide a desired control of the aircraft.

In certain example embodiments, the at least one SSJ comprises a plurality of SSJs and a single one of the SSJs is activated to provide the desired control of the aircraft.

In certain example embodiments, the at least one SSJ comprises a plurality of SSJs and a different one or more of the SSJs is activated to provide a desired control of the aircraft depending on the aircraft's attitude.

In certain example embodiments, the system further comprises an aircraft to which the wing is attached. In certain example embodiments, the aircraft is a tailless aircraft. In certain example embodiments, the aircraft comprises an empennage. In certain example embodiments, the aircraft comprises a vertical stabilizer. In certain example embodiments, the aircraft comprises a horizontal stabilizer.

Described in certain example embodiments herein are systems to control moments and forces on aircraft, comprising a wing comprising a leading edge, the wing having streamlines of airflow over the wing when moving through the air and at least one supersonic steady jet (SSJ) disposed on an upper surface of the SSJ being oriented such that a jet output from the SSJ is angled with respect to the streamlines of the flow over the wing.

In certain example embodiments, the jet output from the SSJ is angled within a range of about 0 degrees to about 180 degrees with respect to the flow over the wing depending on the wing's incidence.

In certain example embodiments, the jet output from the SSJ is angled within a range of about 20 degrees to about 160 degrees with respect to the flow over the wing depending on the wing's incidence.

In certain example embodiments, the jet output from the SSJ is angled within a range of about 30 degrees to about 135 degrees with respect to the flow over the wing depending on the wing's incidence. In some embodiments, the jet output from the SSJ is angled at 30, to/or 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135 degrees with respect to the flow over the wing.

In certain example embodiments, the jet output from the SSJ is angled 45 degrees with respect to the streamlines of the flow over the wing.

In certain example embodiments, the jet output from the SSJ is angled 45 degrees with respect to the streamlines of the flow over the wing an inboard side of the wing for swept-back wings and or on an outboard side of the wing for swept-forward wings.

In certain example embodiments, the at least one SSJ comprises a single SSJ. In certain example embodiments, the at least one SSJ comprises a plurality of SSJs. In certain example embodiments, the at least one SSJ comprises a plurality of SSJs and all the SSJs are activated to provide a desired control of the aircraft. In some embodiments the plurality of SSJs includes one or more pairs of SSJs. In some embodiments, the plurality of SSJs includes 1, 2, 3, 4, 5, 6, or more SSJs.

In certain example embodiments, the at least one SSJ comprises a plurality of SSJs and less than all the SSJs are activated to provide a desired control of the aircraft.

In certain example embodiments, the at least one SSJ comprises a plurality of SSJs and a single one of the SSJs is activated to provide the desired control of the aircraft.

In certain example embodiments, the at least one SSJ comprises a plurality of SSJs and a different one or more of the SSJs is activated to provide a desired control of the aircraft depending on the aircraft's attitude.

In certain example embodiments, the system further comprises an aircraft to which the wing is attached. In certain example embodiments, the aircraft is a tailless aircraft. In certain example embodiments, the aircraft comprises an empennage. In certain example embodiments, the aircraft comprises a vertical stabilizer. In certain example embodiments, the aircraft comprises a horizontal stabilizer.

Described in certain example embodiments herein are systems to control moments and forces on aircraft, comprising a wing comprising a leading edge and a tip; at least one yaw-control supersonic steady jet (SSJ) disposed on an upper surface of the wing near the tip of the wing, activation of the yaw-control SSJ providing a yaw moment to an aircraft to which the wing is attached; and at least one pitch-control SSJ disposed on the upper surface of the wing at an inner position on the wing compared to the location of the yaw-control SSJ, activation of the pitch-control SSJ providing a pitching moment to the aircraft to which the wing is attached.

In certain example embodiments, the system further comprises the aircraft to which the wing is attached. In certain example embodiments, the aircraft is a tailless aircraft. In certain example embodiments, the aircraft comprises an empennage. In certain example embodiments, the aircraft comprises a vertical stabilizer. In certain example embodiments, the aircraft comprises a horizontal stabilizer.

Described in certain example embodiments herein are methods to control moments and forces on aircraft, comprising providing a wing comprising a leading edge; providing at least one supersonic steady jet (SSJ) disposed on an upper surface of the wing, the SSJ being oriented such that a jet output from the SSJ is angled with respect to the leading edge of the wing; and expelling a jet of air from the SSJ.

In certain example embodiments, the jet output from the SSJ is angled within a range of about 0 degrees to about 180 degrees with respect to the leading edge of the wing depending on the wing's incidence.

In certain example embodiments, the jet output from the SSJ is angled within a range of about 20 degrees to about 160 degrees with respect to the leading edge of the wing depending on the wing's incidence.

In certain example embodiments, the jet output from the SSJ is angled within a range of about 30 degrees to about 135 degrees with respect to the leading edge of the wing depending on the wing's incidence. In some embodiments, the jet output from the SSJ is angled at 30, to/or 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135 degrees with respect to the leading edge of the wing.

In certain example embodiments, the jet output from the SSJ is angled 45 degrees with respect to the leading edge of the wing.

In certain example embodiments, the jet output from the SSJ is angled 45 degrees with respect to the leading edge of the wing on an inboard side of the wing for swept-back wings and or on an outboard side of the wing for swept-forward wings.

In certain example embodiments, the at least one SSJ comprises a single SSJ. In certain example embodiments, the at least one SSJ comprises a plurality of SSJs. In some embodiments the plurality of SSJs includes one or more pairs of SSJs. In some embodiments, the plurality of SSJs includes 1, 2, 3, 4, 5, 6, or more SSJs.

In certain example embodiments, the at least one SSJ comprises a plurality of SSJs and all the SSJs are activated to provide a desired control of the aircraft.

In certain example embodiments, the at least one SSJ comprises a plurality of SSJs and less than all the SSJs are activated to provide a desired control of the aircraft.

In certain example embodiments, the at least one SSJ comprises a plurality of SSJs and a single one of the SSJs is activated to provide the desired control of the aircraft.

In certain example embodiments, the at least one SSJ comprises a plurality of SSJs and a different one or more of the SSJs is activated to provide a desired control of the aircraft depending on the aircraft's attitude.

In certain example embodiments, the method further comprises providing an aircraft to which the wing is attached. In certain example embodiments, the aircraft is a tailless aircraft. In certain example embodiments, the aircraft comprises an empennage. In certain example embodiments, the aircraft comprises a vertical stabilizer. In certain example embodiments, the aircraft comprises a horizontal stabilizer.

Described in certain example embodiments, herein are aircraft, or components thereof, such as a wing, comprising a system of the disclosure described herein. In certain example embodiments, the aircraft is a tailless aircraft.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the invention will be obtained by reference to the following detailed description that sets forth illustrative embodiments, in which the principles of the invention may be utilized, and the accompanying drawings of which:

FIG. 1 is a comparison of plan views between the SWEFT, the x-47B, and the suggested x-65, including jet location on the SWIFT design.

FIG. 2 depicts graphs comparing the dependence of lift, drag, and pitching moments on incidence angle for results obtained at CalTech and Arizona.

FIG. 3 depicts a graph illustrating the pressure required to pass a given mass flow through an actuator for various types and sizes of actuators.

FIG. 4 depicts graphs illustrating the between pressure difference across an actuator and the mass flow passing through its nozzle (left); and the dependence of

$$\frac{\text{?}}{{C}_{π , 0}}$$

on the mass flow through an actuator (right).

FIG. 5 depicts graphs illustrating the effect of AFC on pitch using six SJAs (left/middle) or SSJs (right).

FIG. 6 shows oil flow pictures depicting oil flow outboard of the LE crank corresponding to 10°<α<14° (top); oil flow over the entire vehicle at 3 incidence angles (bottom); and flow over the LE of the inner wing (inset).

FIG. 7 shows oil flow over the SWIFT at α=13° (left) and over the SACCON (inset left) compared to China clay on a k-wing (right) and a picture of vortex breakdown on a A-wing.

FIG. 8 shows the effect of 6 SJAs on the flow over the outer wing and near the crank at 10°<α<16°.

FIG. 9 depicts graphs illustrating the effect of AFC on pitch using only pairs of SJAs and SSJs from the LE of the outer wing.

FIG. 10 depicts graphs illustrating the effect of AFC on yaw and roll using pairs of SJAs and SSJs close to the crank (at positions L9-L10).

FIG. 11 depicts graphs illustrating the maximum trimmed CL attained using SJAs (top left) and SSJs (top right) as functions of C_{π,0} for the actuator configurations shown in the figure; and the effect of SJA and SSJ actuation on yaw (bottom).

FIG. 12 depicts graphs illustrating the effect of SSJ orientation on the control of pitch and yaw of the SWIFT model.

FIG. 13 is a block diagram depicting an aircraft flight control system to control forces and moments on aircraft.

FIG. 14 is a block diagram depicting a computing machine and a module.

The figures herein are for illustrative purposes only and are not necessarily drawn to scale.

### DETAILED DESCRIPTION

### Overview

The invention described herein relates to the replacement of conventional moving control surfaces on an aircraft. Sweeping Jet Actuators (“SJAs”) have been used for Active Flow Control (“AFC”). However, a large quantity of SJAs may be necessary, and efficacy of SJAs has only been demonstrated at low speeds (i.e., Mach 0.2 or less). In this disclosure, Supersonic Steady Jets (SSJs) are used as control surface replacements for aircraft at any subsonic cruising speed. The SSJs are distributed on the aircraft in locations and orientations that take into consideration changing local flow conditions on the surface of the aircraft. Even a single SSJ properly located and oriented on the aircraft may outperform an array of SJAs. In one example, when a single SSJ was used to control the pitch of the aircraft, the single SSJ increased the trimmed lift almost as well as an array of SJAs, while providing better yaw control at a small accompanying rolling moment.

### Systems and Methods to Control Moments and Forces on Aircraft

Generally, controlling moments and forces on tailless aircraft refers to the mechanisms and techniques used to maintain stability and control in aircraft that lack a distinct horizontal stabilizer and elevator configuration, commonly known as a tailless or flying-wing design. Tailless aircraft typically rely on alternative means to achieve stability and control, such as wing shaping, wing twist, differential wing control, thrust vectoring, and advanced control surfaces. Described in certain example embodiments herein are systems and methods to control moments and forces on aircraft, including tailless aircraft, as shown and described herein.

### Systems to Control Moments and Forces on Aircraft

Described in certain example embodiments herein are systems to control moments and forces on aircraft, comprising a wing comprising a leading edge; and at least one supersonic steady jet (SSJ) disposed on an upper surface of the wing, the SSJ being oriented such that a jet output from the SSJ is angled with respect to the leading edge of the wing.

In certain example embodiments, the jet output from the SSJ is angled within a range of about 0 degrees to about 180 degrees with respect to the leading edge of the wing depending on the wing's incidence.

In certain example embodiments, the jet output from the SSJ is angled within a range of about 20 degrees to about 160 degrees with respect to the leading edge of the wing depending on the wing's incidence.

In certain example embodiments, the jet output from the SSJ is angled within a range of about 30 degrees to about 135 degrees with respect to the leading edge of the wing depending on the wing's incidence. In some embodiments, the jet output from the SSJ is angled at 30, to/or 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135 degrees with respect to the leading edge of the wing.

In certain example embodiments, the jet output from the SSJ is angled 45 degrees with respect to the leading edge of the wing.

In certain example embodiments, the jet output from the SSJ is angled 45 degrees with respect to the leading edge of the wing on an inboard side of the wing for swept-back wings and or on an outboard side of the wing for swept-forward wings. In certain example embodiments, the at least one SSJ comprises a single SSJ. In certain example embodiments, the at least one SSJ comprises a plurality of SSJs. In some embodiments the plurality of SSJs includes one or more pairs of SSJs. In some embodiments, the plurality of SSJs includes 1, 2, 3, 4, 5, 6, or more SSJs.

In certain example embodiments, the at least one SSJ comprises a plurality of SSJs and all the SSJs are activated to provide a desired control of the aircraft.

In certain example embodiments, the at least one SSJ comprises a plurality of SSJs and less than all the SSJs are activated to provide a desired control of the aircraft.

In certain example embodiments, the at least one SSJ comprises a plurality of SSJs and a single one of the SSJs is activated to provide the desired control of the aircraft.

In certain example embodiments, the at least one SSJ comprises a plurality of SSJs and a different one or more of the SSJs is activated to provide a desired control of the aircraft depending on the aircraft's attitude.

In certain example embodiments, the system further comprises an aircraft to which the wing is attached. In certain example embodiments, the aircraft is a tailless aircraft. In certain example embodiments, the aircraft comprises an empennage. In certain example embodiments, the aircraft comprises a vertical stabilizer. In certain example embodiments, the aircraft comprises a horizontal stabilizer.

Described in certain example embodiments herein are systems to control moments and forces on aircraft, comprising a wing comprising a leading edge, the wing having streamlines of airflow over the wing when moving through the air and at least one supersonic steady jet (SSJ) disposed on an upper surface of the SSJ being oriented such that a jet output from the SSJ is angled with respect to the streamlines of the flow over the wing.

In certain example embodiments, the jet output from the SSJ is angled within a range of about 0 degrees to about 180 degrees with respect to the flow over the wing depending on the wing's incidence.

In certain example embodiments, the jet output from the SSJ is angled within a range of about 20 degrees to about 160 degrees with respect to the flow over the wing depending on the wing's incidence.

In certain example embodiments, the jet output from the SSJ is angled within a range of about 30 degrees to about 135 degrees with respect to the flow over the wing depending on the wing's incidence. In some embodiments, the jet output from the SSJ is angled at 30, to/or 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135 degrees with respect to the flow over the wing.

In certain example embodiments, the jet output from the SSJ is angled 45 degrees with respect to the streamlines of the flow over the wing.

In certain example embodiments, the jet output from the SSJ is angled 45 degrees with respect to the streamlines of the flow over the wing an inboard side of the wing for swept-back wings and or on an outboard side of the wing for swept-forward wings.

In certain example embodiments, the at least one SSJ comprises a single SSJ. In certain example embodiments, the at least one SSJ comprises a plurality of SSJs. In certain example embodiments, the at least one SSJ comprises a plurality of SSJs and all the SSJs are activated to provide a desired control of the aircraft. In some embodiments the plurality of SSJs includes one or more pairs of SSJs. In some embodiments, the plurality of SSJs includes 1, 2, 3, 4, 5, 6, or more SSJs.

In certain example embodiments, the at least one SSJ comprises a plurality of SSJs and less than all the SSJs are activated to provide a desired control of the aircraft.

In certain example embodiments, the at least one SSJ comprises a plurality of SSJs and a single one of the SSJs is activated to provide the desired control of the aircraft.

In certain example embodiments, the at least one SSJ comprises a plurality of SSJs and a different one or more of the SSJs is activated to provide a desired control of the aircraft depending on the aircraft's attitude.

In certain example embodiments, the system further comprises an aircraft to which the wing is attached. In certain example embodiments, the aircraft is a tailless aircraft. In certain example embodiments, the aircraft comprises an empennage. In certain example embodiments, the aircraft comprises a vertical stabilizer. In certain example embodiments, the aircraft comprises a horizontal stabilizer.

Described in certain example embodiments herein are systems to control moments and forces on aircraft, comprising a wing comprising a leading edge and a tip; at least one yaw-control supersonic steady jet (SSJ) disposed on an upper surface of the wing near the tip of the wing, activation of the yaw-control SSJ providing a yaw moment to an aircraft to which the wing is attached; and at least one pitch-control SSJ disposed on the upper surface of the wing at an inner position on the wing compared to the location of the yaw-control SSJ, activation of the pitch-control SSJ providing a pitching moment to the aircraft to which the wing is attached.

In certain example embodiments, the system further comprises the aircraft to which the wing is attached. In certain example embodiments, the aircraft is a tailless aircraft. In certain example embodiments, the aircraft comprises an empennage. In certain example embodiments, the aircraft comprises a vertical stabilizer. In certain example embodiments, the aircraft comprises a horizontal stabilizer.

As described the systems described herein can be included in an aircraft, such as a tailless aircraft. Thus, also within the scope of the present disclosure are aircraft, or a component thereof, such as a wing, that includes a system or component thereof of the disclosure described herein. In certain example embodiments, the aircraft is a tailless aircraft. In some embodiments, the aircraft is a supersonic aircraft. In some embodiments, one or more current tailless aircraft can be modified so as to include the system of the present disclosure.

Methods to Control Moments and forces on Aircraft

Described in certain example embodiments herein are methods to control moments and forces on aircraft, comprising providing a wing comprising a leading edge; providing at least one supersonic steady jet (SSJ) disposed on an upper surface of the wing, the SSJ being oriented such that a jet output from the SSJ is angled with respect to the leading edge of the wing; and expelling a jet of air from the SSJ.

In certain example embodiments, the jet output from the SSJ is angled within a range of about 0 degrees to about 180 degrees with respect to the leading edge of the wing depending on the wing's incidence.

In certain example embodiments, the jet output from the SSJ is angled within a range of about 20 degrees to about 160 degrees with respect to the leading edge of the wing depending on the wing's incidence.

In certain example embodiments, the jet output from the SSJ is angled within a range of about 30 degrees to about 135 degrees with respect to the leading edge of the wing depending on the wing's incidence. In some embodiments, the jet output from the SSJ is angled at 30, to/or 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135 degrees with respect to the leading edge of the wing.

In certain example embodiments, the jet output from the SSJ is angled 45 degrees with respect to the leading edge of the wing.

In certain example embodiments, the jet output from the SSJ is angled 45 degrees with respect to the leading edge of the wing on an inboard side of the wing for swept-back wings and or on an outboard side of the wing for swept-forward wings.

In certain example embodiments, the at least one SSJ comprises a single SSJ. In certain example embodiments, the at least one SSJ comprises a plurality of SSJs. In some embodiments the plurality of SSJs includes one or more pairs of SSJs. In some embodiments, the plurality of SSJs includes 1, 2, 3, 4, 5, 6, or more SSJs.

In certain example embodiments, the at least one SSJ comprises a plurality of SSJs and all the SSJs are activated to provide a desired control of the aircraft.

In certain example embodiments, the at least one SSJ comprises a plurality of SSJs and less than all the SSJs are activated to provide a desired control of the aircraft.

In certain example embodiments, the at least one SSJ comprises a plurality of SSJs and a single one of the SSJs is activated to provide the desired control of the aircraft.

In certain example embodiments, the at least one SSJ comprises a plurality of SSJs and a different one or more of the SSJs is activated to provide a desired control of the aircraft depending on the aircraft's attitude.

In certain example embodiments, the method further comprises providing an aircraft to which the wing is attached. In certain example embodiments, the aircraft is a tailless aircraft. In certain example embodiments, the aircraft comprises an empennage. In certain example embodiments, the aircraft comprises a vertical stabilizer. In certain example embodiments, the aircraft comprises a horizontal stabilizer.

### Examples

Now having described the embodiments of the present disclosure, in general, the following Examples describe some additional embodiments, features, and attributes of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure. The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for.

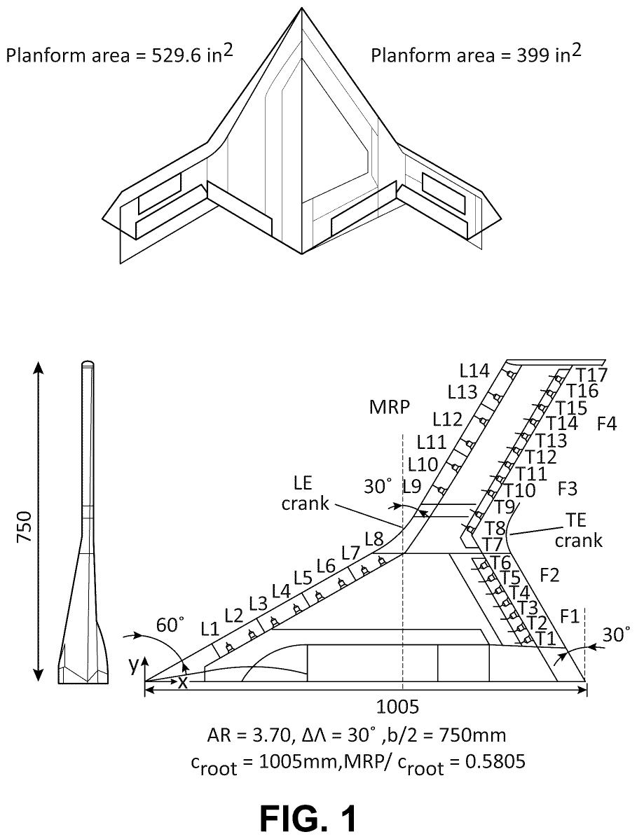

The examples will now be discussed in more detail herein with reference to FIGS. 1-12.

Replacement of conventional moving control surfaces on typical tailless aircraft, or other aircraft types, is possible at high subsonic cruise speeds. Since the efficacy of Sweeping Jet Actuators (SJAs) was only demonstrated at low speeds, the current test considered their potential replacement by Supersonic Steady Jets (SSJs) of the same size. It was shown that even a single jet properly located and oriented may outperform an array of actuators whose location and orientation did not take into consideration the changing local flow conditions. The test article chosen was the SWIFT model that represents a typical blended wing-body configuration of a tailless aircraft. It was selected because it was tested extensively using SJAs. When a single supersonic jet designed for Mn=1.5 was used to control the pitch, it was able to increase the trimmed lift almost as well as an array of SJAs while providing a much better yaw control at small accompanying rolling moment.

These tests proved that the momentum input is but one of many parameters controlling the flow. It was replaced by power coefficients that are unambiguously measured and can compare various modes of actuation.

In this section, the following Nomenclature applies:
[symbol] =Aⱼ/S; jet-to-wing area ratio
Aⱼ=total jet exit area
A_{R}=wing aspect ratio
b=wing span
C_{L}=lift coefficient

$${C}_{ℳ} = \frac{{\dot{m}}_{j}}{{ρ}_{∞} {u}_{∞} S} ;$$

mass flow coefficient

$${C}_{Q} = \frac{{Q}_{j}}{{u}_{∞} S} ;$$

volume flow coefficient

$${C}_{T} = \frac{T}{j} ;$$

thrust coefficient

$${C}_{μ} = \frac{J}{\frac{1}{2} {ρ}_{∞} {u}_{∞}^{2} S} ;$$

momentum coefficient

$${C}_{μ , 0} = 4 𝒜 \frac{{p}_{0} - {p}_{∞}}{{ρ}_{∞} {u}_{∞}^{2}} ;$$

plenum momentum coefficient

$${C}_{μ , ℳ} = 2 \frac{{C}_{ℳ}^{2}}{𝒜} ;$$

mass flow momentum coefficient

$${C}_{π} = \frac{{ρ}_{j} {u}_{j}^{3} {A}_{j}}{\frac{1}{2} {ρ}_{∞} {u}_{∞}^{3} S} ;$$

power coefficient

$${C}_{π , ℳ} = 2 \frac{{c}_{ℳ}^{3}}{{𝒜}^{2}} ;$$

mass flow power coefficient

$${C}_{π , 0} = 4 {C}_{ℳ} \frac{{p}_{o} - {p}_{∞}}{{ρ}_{∞} {u}_{∞}^{2}} ;$$

plenum power coefficient

$${C}_{π , sys} = 4 {C}_{ℳ} \frac{{p}_{t} - {p}_{∞}}{{ρ}_{∞} {u}_{∞}^{2}} ;$$

system power coefficient
J=\dot{m}ⱼ\dot{u}ⱼ; jet momentum flux
\dot{m}=ρuA; mass flux
Mₙ=Mach number
nⱼ=number of sweeping jet actuators
S=wing platform area
u=velocity
α=angle of incidence
β=jet orientation angle relative to the LE of the outer wing
δ=flap deflection
Λ=wing sweep
ξₛ=spacing between actuators
ρ=density

### Subscripts

θ=total pressure
j=jet nozzle exit
t=total pressure at system entrance
∞=free stream

Acronyms

| | |
|---|---|
| AC | aerodynamic center |
| AFC | active flow control |
| LE | leading edge |
| LEV | LE vortex |
| MRP | mean rotation point. |
| SJA | sweeping jet actuator. |
| SSJ | steady supersonic jet. |
| TE | trailing edge |

Active Flow Control (AFC) research that evolved from Boundary Layer & Circulation Control (BLC & CC) concepts focused initially on the prevention of separation of two-dimensional flow from airfoils at high incidence angles. The purpose of this research was to lower the takeoff and landing speeds by increasing the maximum lift obtained on conventional airplanes. However, as the cruise speed increased and the wings swept back or evolved into tailless, blended wing body aircraft, the interest in AFC shifted toward stability and control. This shift is because tailless configurations lack the “long-arm” that is needed to control the moments around two of the three axes of rotation. The control problem is most severe on stealthy configurations where vertical stabilizers are avoided and deflectable control surfaces are undesirable.

Blowing compressed air over the surface of wings and deflected flaps was the only technique that reached mass production on combat jet aircraft manufactured during the second half of the 20^{th} century (e.g., F-104, Etandard-IVM, and Mig-21). Since BLC coincided with the introduction of the jet engine and used it for the needed air supply, momentum coefficient that was akin to stationary (dry) thrust coefficient of a jet engine was established as the leading parameter measuring the efficacy of the BLC system. The deficiencies of this definition were recognized early, but they were disregarded because, in two-dimensional flow, replenishing the momentum lost to friction recovers the ideal flow solution that reestablishes the pressure distribution on an airfoil, which was an important design criterion. Furthermore, since the engine compressor was the sole source of momentum considered, the definition stuck. The destabilization of the boundary layer by periodic pulsing opened a new path for BLC as it lowered the input requirements by an order of magnitude. It enabled the use of electromagnetic, piezo-electric, and plasma actuators in addition to fluidic amplifiers that could be driven directly by micro-compressors.

The multitude of actuators requires quantitative means of comparison, and the most logical criterion to judge them is by the power that they consume. This approach permitted the inclusion of passive devices that also consume energy by adding to the drag of the airplane. Added weight, cost, maintainability, and reliability add to the complexity of the decision-making process.

Sweeping Jet Actuators (SJAs) dominated the AFC research in recent years because they are small, have no moving parts, and the sweeping motion covers a large surface area that may help the control of traditional separation. In the case of three-dimensional flows whose local direction may not be known, they forgive directional misalignment errors. However, they too require high pressure air that in the case of the Boeing-757 vertical tail tests was provided by means external to the AFC system, although micro compressors attached to subsets of actuators might have been more effective. This notwithstanding, the purpose of the actuation on finite swept wings and tailless aircraft is to change the direction of the flow and the path of the leading-edge vortex, thereby controlling the pitch and the yaw. Jet-curtains that are created by sparsely distributed sweeping or steady jet actuators entrain and redirect the surrounding flow, thus mostly inhibiting the spanwise flow over the wing. The jet effectiveness is determined by its high velocity relative to the surrounding flow. Only such a concept could explain the large effect that a single SJA had on the side force generated by the vertical tail of the 757, when a jet emerging from a small, single nozzle affected the force generated by the vertical tail whose area was almost six orders of magnitude larger. This result brought to question the utility of the SJAs relative to steady high-speed jets whose purpose is to alter the direction of the flow near the solid surface.

The efficacy of sweeping jets relative to steady ones was tested on the aft concave surface of a two-dimensional hump model, with the conclusion that SJAs are more effective in controlling separation than steady jets, but that conclusion is limited to two-dimensional, low speed flows over concave surfaces. Since the “jet-curtain” concept requires a high-speed jet, the pressure losses in the interior of the SJAs might be prohibitive. It is thus believed that a more realistic comparison between SJAs and steady jets is in order under otherwise identical test conditions. The model chosen for this comparison is the SWIFT model that represents a generic blended wing configuration currently tested at high Reynolds numbers at the National Transonic Facility at NASA. It was extensively tested at CalTech. The tests were carried out at the ALSWT (Arizona Low Speed Wind Tunnel) whose test section (3′×4′) is considerably smaller than the (5′×6′) Lucas tunnel at CalTech, and therefore all the tests selected for the comparison were repeated, to avoid accounting for differences in wind tunnel corrections.

Compressors can be characterized by the mass flow passing through them and the pressure difference that they generate. Thus, the product of these two quantities is akin to fluidic power, and it may define the efficacy of the AFC system. Furthermore, since the pressure drops along the way, additional pressure measurements enable the assessment of the power consumed by each component of the AFC system and help the sizing of the actuators and their supply lines. This brought to focus the interior losses of the SJAs and inspired the present tests where both mass flow and power coefficients are reported. The tests were carried out at Reynolds number Re=1.66×10⁶ based on the root chord.

The test article: The SWIFT is a blended wing-body tailless aircraft model (depicted by shading in FIG. 1 overlayed on the left side of the X-47B outline, which is shown in blackline). It has a diamond shaped inner wing attached to a non-tapered outer wing with a much lower sweep-back. Its planform is like the Northrop-Grumman's X-47B (outlined in black in FIG. 1) and Aurora's Coplanar Joined Wing (CJW), X-65, that was designed for DARPA's CRANE program (depicted by shading in FIG. 1 overlayed on the right side of the X-47B outline). It has a LE crank located close to its mid-span that reduces the LE sweep by ΔΛ=30°. The airfoil sections are cambered, and an outwash is employed on the outer wing to delay and reduce the pitch instability. The thick inner body of the SWIFT provides a large internal volume, while most of its outer wing is based on a 10% thick airfoil. Although its wing area is 32% larger than CJW's, when both models have identical inner chord, its maximum baseline L/D is 30% larger at the same Re. There are four independently adjustable flaps that were not used in this study. Most important dimensions of the model are shown in FIG. 1.

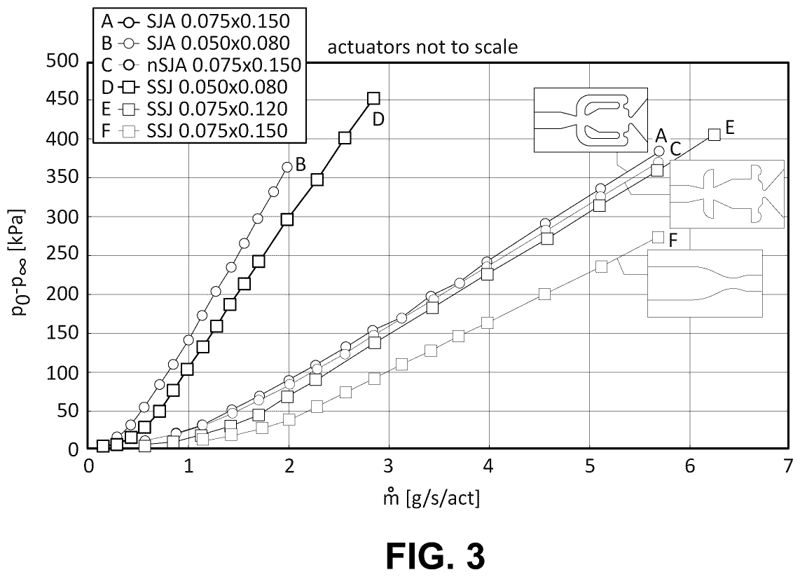

The model was equipped with 31 sweeping jet actuators (14 LE actuators and 17 TE actuators) but only some of them that were located mostly on the outer wing or close to the crank, were used during the present investigation. The initial orientation of the jets used presently was perpendicular to the LE (0=90°), but this angle was altered later when a small number of actuators was used. The jets were inclined with respect to the x-y plane such that the jet outlet was embedded in the model's upper mold, while the rest of the actuator was internal to the structure. The sweeping jets themselves were high-pressure fluidic oscillators. The initial set of actuators had nozzle cross-sectional dimensions of 0.050″×0.080″ and an opening angle of 1000 (see inset to FIG. 3). The SJAs were later replaced by simple supersonic nozzles designed for Mₙ=1.5 under ideal conditions. Their original throat dimensions were identical to the SJAs, and their orientation was also. However, as the study proceeded, their orientation was changed, and when a single SSJ was tested, its nozzle size was also increased to 0.075″×0.120″.

### Results

### (i) Brief Comparison of Test Results Obtained in the Lucas Tunnel at CalTech and at the University of Arizona (ALSWT)

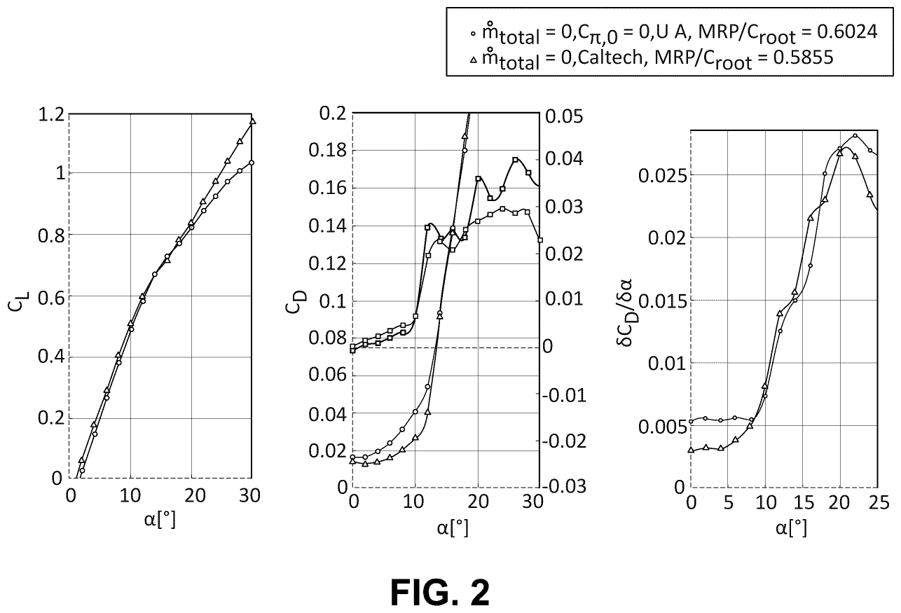

A small subset of the test results obtained in the two wind tunnels were compared to ensure that the much smaller Arizona wind tunnel did not render the results meaningless. The dependence of lift, drag, and pitching moment on incidence taken at Δα=2° intervals are plotted in FIG. 2 and compared to the results obtained at the Lucas tunnel at CalTech. All actuators were taped over by Kapton tape for the purpose of this comparison.

The lift coefficient is slightly higher than the C_{L} measured at CalTech due to the closer proximity of the wind tunnel walls affecting the free streamline curvature. Thus, as long as the flow is fully attached (i.e., for α<12°), a small correction in incidence of Δα<0.50 would collapse the two lift curves onto one. At α>20° the differences in measured lift increase due to blockage (both solid and wake blockage). The drag is most affected by the wake blockage, and it is lower at ALSWT. However, the abrupt increase in (dC_{D}/dα) that was associated with the lift-off of the LEV was observed in both tests at α>8°, leading to the conclusion that, despite the larger tunnel interference, the flow over the model retains its character. The nose-up pitch departure occurs at α≈6° at the ALSWT and at α≈8° at CalTech (FIG. 2 right), suggesting that nose-up pitch departure is not associated with the LEV's lift-off that occurs at higher a.

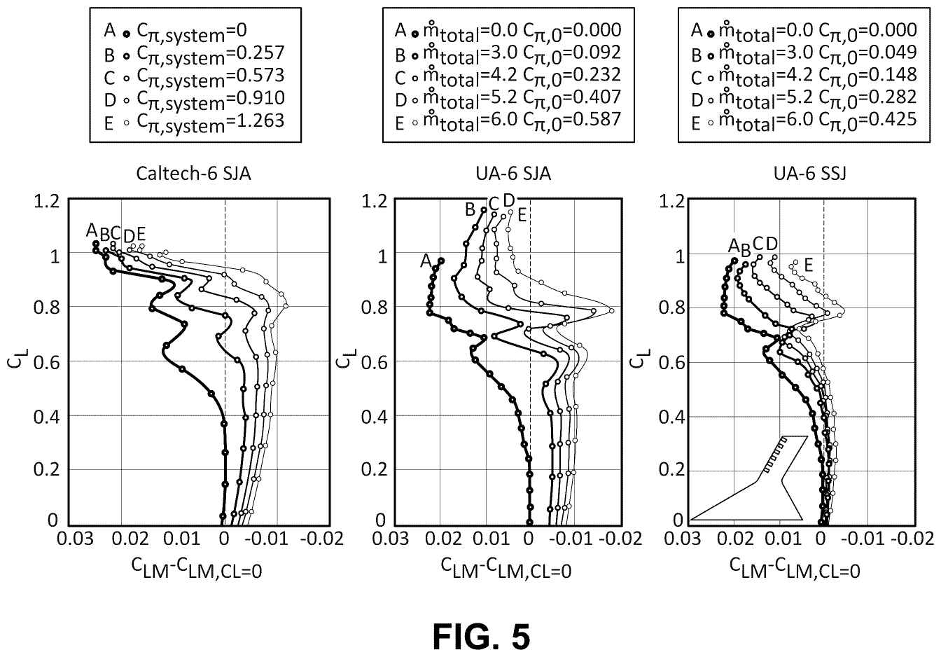

To assure that there are no major differences in the two test setups with regards to pitch control when SJAs were used, actuation from the LE was applied to the outer wing at identical C_{μ} intervals. Although the absolute value of C_{LM} at C_{L}=0 was somewhat different, the effect of actuation on ΔC_{LM} was similar (FIG. 5). Note that in FIG. 5, the graphed lines are depicted in the same order left-to-right as the references are listed top-to-bottom in the legend. Thus, the Aerodynamic Center (AC) where ∂C_{LM}/∂_{L}=0 could be maintained by gradually increasing the level of actuation effectively doubling the C_{L} without the need to change the trim but using C_{μ}=1% instead. The actuation from the LE creates this advantage by controlling the strength and the path of the LEV. It is interesting to note that the initial nose-up pitch departure occurred presently at lower C_{L} than it did at CalTech, and effects of the LEV lift-off were also more pronounced than they were in the larger wind tunnel.

These results cleared the way for a systematic comparison of actuation techniques based on coefficients derived from conservation of mass flow and pressure losses:

$${C}_{μ , ℳ} = 2 \frac{{C}_{ℳ}^{2}}{𝒜} while {C}_{π , ℳ} = 2 \frac{{C}_{ℳ}^{3}}{{𝒜}^{2}} \& {C}_{μ , 0} = 4 𝒜 \frac{{p}_{0} - {p}_{∞}}{{ρ}_{∞} {u}_{∞}^{2}} while {C}_{π , 0} = 4 {C}_{ℳ} \frac{{p}_{t} - {p}_{∞}}{{ρ}_{∞} {u}_{∞}^{2}} .$$

The ratio between each pair of variables

$$\frac{\text{?}}{{C}_{π , 0}} or \frac{\text{?}}{{C}_{μ , 0}}$$

is the same, and it is a measure of the pressure loss in each AFC component. It is therefore independent of the specific choice of the variable.

### (ii) Pressure Losses Across the Actuators Used

The pressure required for a given mass flow to pass through an actuator is plotted in FIG. 3. Three types of actuators were considered in the figure: an SJA; a non-sweeping SJA (nSJA) whose feedback loop channels were blocked; and a simple supersonic jet nozzle (SSJ) designed for Mₙ=1.5 under ideal conditions (square symbols in FIG. 3). Three sizes of actuators were calibrated, but unless it is explicitly stated, the smallest sizes of 0.050″×0.080″ were used. The shapes of the actuators are sketched in the inset. For a given nozzle size (say 0.075×0.150″), the SJA required the highest pressure to pass a given mass flow through. Blocking the feedback channel reduced the pressure loss by a small amount (the third symbol in the legend list and the fourth line to the right/bottom in the graph), but the simple supersonic nozzle required much lower pressure to pass a given mass flow (the last symbol in the legend list and the right/bottom line in the graph). The steady supersonic nozzle delivered more momentum to the flow for a given input pressure, but it did so at a given direction while the SJA provided an oscillating output bound by approximately 100° of sweep angles. The aerodynamic performance of the SJAs was compared to the SSJs for the smallest actuators only, because the outer wing of the model could not accommodate the larger SJA actuators.

The power coefficient, C_{π,0}, consists of a product of the mass flow passing through an actuator and the total pressure difference measured across it, normalized by similar quantities representing the model in the free stream. The total pressure could also be measured at the entry to the AFC system to assess the losses in the supply chain. Intermediate, additional measurements of pₜ may define the losses in each component of the air supply system, but this was not done presently. No further assumptions are needed in determining C_{π,0}. A similar coefficient that is based on the conservation of mass flow

$$( \text{?} = 2 \frac{\text{?}}{\text{?}}$$

where [symbol] is the jet-to-wing area ratio), can also be used, rendering the ratio of the two:

$$\frac{\text{?}}{{C}_{π , 0}} = \frac{( \frac{{ρ}_{j}}{{ρ}_{∞}} ) \frac{1}{z} {ρ}_{j} {u}_{j}^{2}}{( {p}_{0} - {p}_{∞} )} = \frac{( \frac{{ρ}_{j}}{{ρ}_{∞}} )}{( {C}_{p j} )} , where {C}_{p j} = \frac{( {p}_{0} - {p}_{∞} )}{\frac{1}{2} {ρ}_{j} {u}_{j}^{2}}$$

$$\frac{\text{?}}{{C}_{π , 0}}$$

represents a quotient of two effects:
(i) density ratio of the air going through the actuator;

$$\frac{{ρ}_{j}}{{ρ}_{∞}} > 1$$

and it increases with increasing input pressure irrespective of the manner in which the air is compressed (i.e., adiabatically, isothermally, or anything in between).
(ii) the pressure required at the actuator's inlet to create a jet of a given

$${ρ}_{j} {u}_{j}^{2}$$

at its outlet. {Cₚⱼ}⁻¹ represents the efficiency of the actuator because it requires a larger input than predicted by using Bernoulli's equation. Since it represents losses in the interior of the actuator that increase with increasing mass flow, this term will reduce the ratio of

$$\frac{\text{?}}{{C}_{π , 0}}$$

with increasing \hat{m}ⱼ.

If there were no losses inside the actuator, p₀ at its inlet would have been equal to the p₀ at the nozzle exit, and the inlet pressure would only be responsible for compressing the air resulting in

$$\frac{\text{?}}{{C}_{π , 0}} = \frac{{ρ}_{j}}{{ρ}_{∞}} > 1$$

Consequently, for incompressible fluid in the absence of frictional losses

$$\frac{\text{?}}{{C}_{π , 0}} = 1 .$$

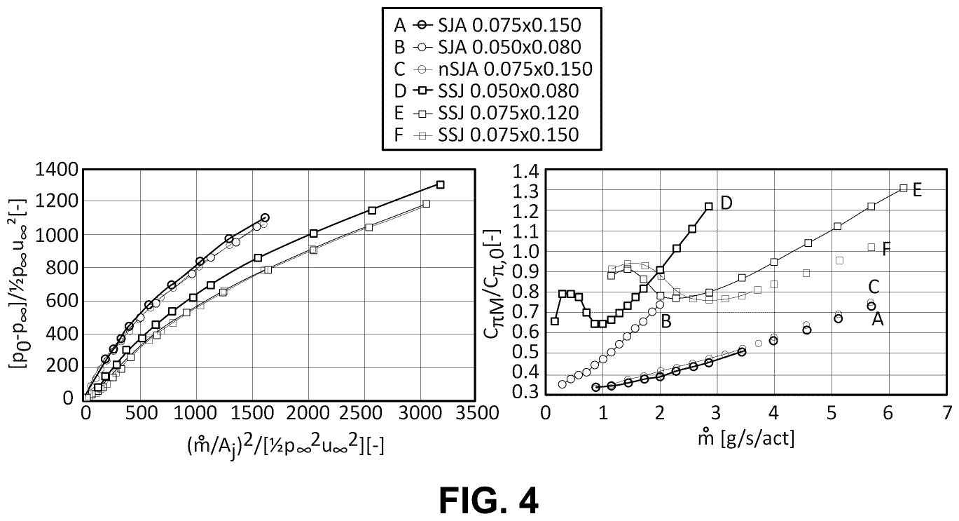

Thus, an incompressible and inviscid approximation would lead to the mass flow being proportional to the square root of the pressure drop, as it indeed appears to be as shown in FIG. 4 left.

It is a reasonable approximation for subsonic SJAs and their non-sweeping variants because the SJA results plotted in FIG. 4 collapse almost onto a single curve irrespective of the size of the actuators. The SSJs, in contrast, seemed to be size dependent. Since the internal losses in the SJAs are much larger than in the SSJs of the same dimensions, their ratio of

$$\frac{\text{?}}{{C}_{π , 0}}$$

is much lower (FIG. 4). Increasing their size increases the mass flow through them thus increasing the frictional losses resulting in smaller

$$\frac{\text{?}}{{C}_{π , 0}} .$$

Rectangular convergent-divergent nozzles designed to create a supersonic jet (SSJ) at a prescribed pressure ratio have relatively little losses resulting from their finite aspect ratio (corner vortices) and friction with their interior walls. They therefore have a much larger ratio of

$$\frac{\text{?}}{{C}_{π , 0}}$$

than SJAs of identical nozzle size. Increasing rh at very low incompressible speeds increases the losses resulting in reduction of

$$\frac{\text{?}}{{C}_{π , 0}} ,$$

but when compressibility kicks in, the slope of

$$\frac{d ( \frac{\text{?}}{{C}_{π , 0}} )}{d \dot{m}}$$

becomes more moderate, vanishing at Mₙ=1 and thereafter increases due to an increase in

$$\frac{{ρ}_{j}}{{ρ}_{∞}}$$

### (FIG. 4).

The supply lines connecting the compressed air source to the actuators add to the power loss of the AFC system. By subtracting the total pressure measured at the inlet to the actuators from the source pressure at the entrance to the AFC system, the supply line losses that depend on the aggregate mass flow can be estimated. For this reason, the use of many actuators, increasing the mass flow in the main supply lines, is detrimental. The supply line losses are of little concern. Pipe-line losses determine whether to use dedicated micro-compressors or whether to bleed an engine or install a dedicated APU unit.

(iii) Maintenance of AC at High C_{L} by LE Actuation on the Outer Wing

The basic model maintains its aerodynamic center in ALSWT up to C_{L}≈0.25 (FIG. 5). Thereafter, it experiences a nose-up pitch departure that requires intervention either by movement of a control surface or by AFC. When the entire LE array of SJAs is activated at the appropriate level in a direction normal to the LE, the model may retain its trimmed condition up to C_{L,trim}≈0.9 or increase the trim possibility by approximately 350%. However, the initial nose-up pitch departure is followed by a large nose down trend that reverses itself once again at a slight increase in incidence. This would require rapid pitch control algorithms that most probably will need closed-loop control techniques requiring sensors to be placed on the wing.

Replacing the SJAs with SSJs and using the same size actuators oriented in the same direction proved ineffective, as it increased the trimmed C_{L}≈0.6 at identical maximum mass flow used ( [symbol] =0.278). Although the SSJ had a smaller pressure drop across the actuator that could be used to push more flow through it, comparing the two actuation systems at identical Cn did not alter the conclusion. Sweeping jets do better when a “carpet approach” is taken covering as large a surface as possible by jet flow. The effect of SJAs on the pitch is much larger than the effect of the SSJs even at α<6° where the flow is attached everywhere. For example: the SJAs generated a ΔC_{LM}≈−0.005 relative to the baseline flow at the smallest mass flow tested at [symbol] =0.035, but the same mass flow generated only a ΔC_{LM}=−0.0015 when SSJs were used, prior to the nose-up pitch departure. Clearly, the sweeping jets entrain ambient air more effectively and cover a larger surface area than the steady jets, and that is their major advantage. The SSJs, however, moderated the pitch departures in both directions therefore requiring a simpler controller to maintain the trimmed aerodynamic center in that mode of application (i.e., when arrays of closely spaced jets are being used).

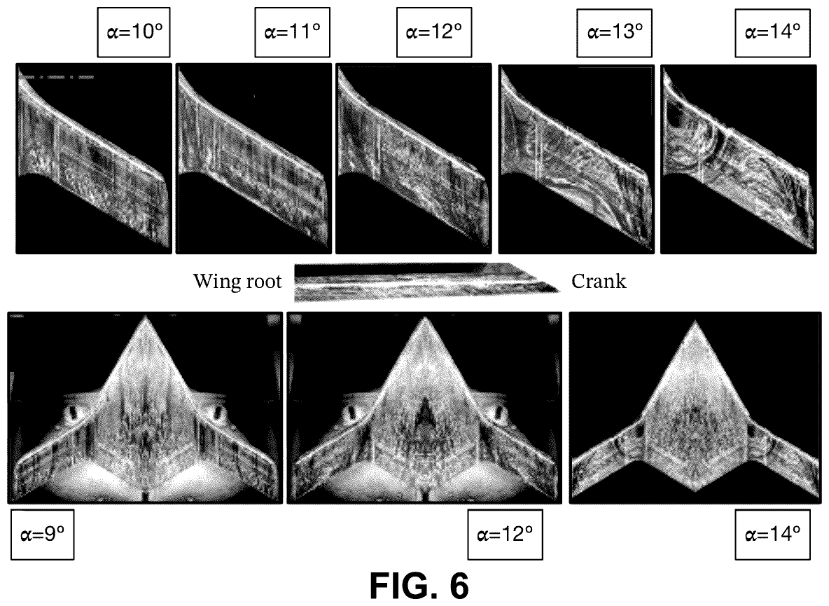

Surface oil flow (FIG. 6) revealed the direction of the surface streamlines from which the footprint of vortices could also be inferred. The most obvious feature observed while increasing incidence in the absence of actuation, is the increase of spanwise flow over the aft portion of the outboard wing. At α=10°, the surface streamlines are inclined at approximately 30° to the free stream while at α=12° they become almost parallel to the wing's TE over a spanwise extent of half the wing's span (FIG. 6 top center). Since the most severe nose-up pitch departures occur in the range of 7°<α<12°, it is the TE spanwise flow that that results in pressure increase over the outer wing and thus nose-up pitching moment. It seemed plausible that the low pressure generated near the LE of the inboard trapezoidal part of the wing would also affect the pitch-up, but this action would not explain similar behavior on a simple swept back wing. This notwithstanding, the existence of a LEV may be detected on the inboard wing by examining the oil flow between the LE and the trip-strip (FIG. 6 center insert). At α=12° the reattachment line that is black in this photograph is visible from the crank inboard, reaching almost the root of the wing. The reattachment line is mostly parallel to the LE near the wing root, but it approaches the LE from a point located approximately midway between the root and the crank, coinciding with the LE near the crank. This footprint of the LEV suggests that the LEV moves away from the surface as it approaches the crank due to the deceleration of the spanwise flow caused by the crank. This might have lifted the vortex core from the surface that is marked by the movement of the reattachment line toward the LE. At α=13°, the LEV was lifted from the surface just outboard of the crank and it was pushed by the free stream toward the TE and outboard toward the wingtip.

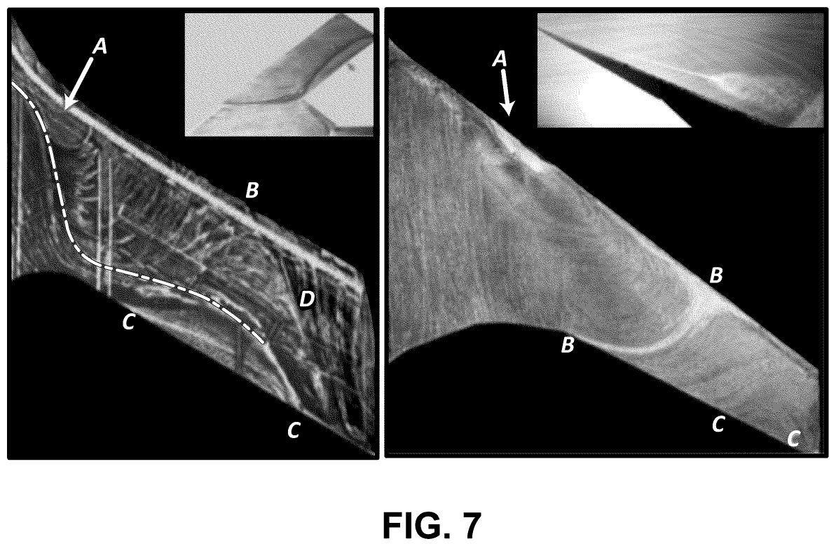

The schematic path of the vortex core at α=13° is shown in FIG. 7 by the broken yellow line. It was constructed based on previous experience with the SACCON and with simple 2-wings where the vortex breakdown and liftoff were more moderate, allowing following of the process at small increments of α. The focus of the separation occurs at the LE just downstream of the crank, and it is marked by the letter “A” in FIG. 7. On the X-wing (FIG. 7 right) more clay was accumulated at separation because of the more moderate liftoff. The footprint of the vortex on this wing expands rapidly because of vortex breakdown as was observed on a delta wing where air bubbles in water served to visualize the flow, and they are shown in the inset to FIG. 7 right.

A quasi-stationary vortex that is parallel to the TE of the outer wing and located above it will induce flow reversal over the aft portion of the wing, as seen by the oil flow between the two “C”s in FIG. 7. The extent of the distance between the two letters “C” is indicative of the strength of the vortex and its location. It generates a low-pressure bubble near the LE that is clearly visible on the λ-wing due to accumulation of clay particles coming from the TE to the LE (marked by letter “B”) and the absence of a trip strip on this wing. Thus, one expects a LE bubble between A & B on both wings and a strong tip vortex “D” on the SWIFT. The tip vortex reattaches the flow near the tip and merges with the LEV in the lee of the wing. Hence, the liftoff of the LEV and its path above the outer wing lowers the pressure momentarily (over a small Δα) over it, creating a nose-down pitch. Increasing the incidence further results in a total separation of the flow over the outer wing, strengthening the LEV on the inner wing and moving the separation focal point inboard of the MRP (FIG. 6 α=14°). Both effects result in a strong nose up pitch. Similar observations were made by others on the SACCON model using oil flow and CFD. In the SACCON's case, the LEV was diverted by an abrupt change in the LE radius that was intentionally placed opposite a TE crank of the λ-wing. The control of the pitch in that case was attained by SJAs located near the TE of the outer wing.

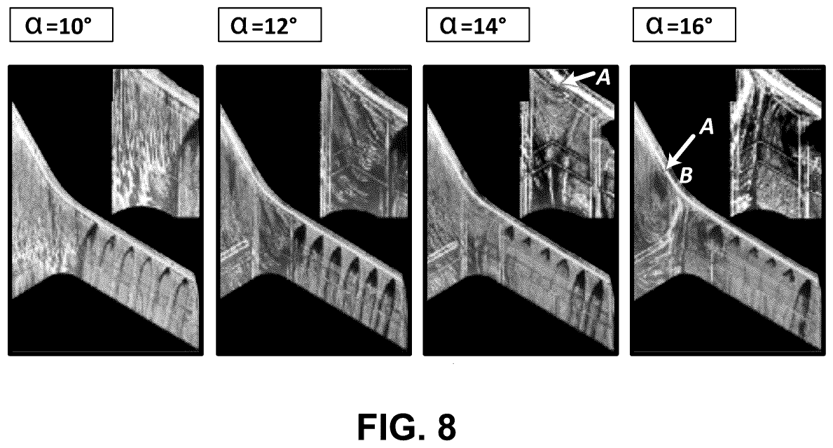

The introduction of 6 SJAs near the LE of the outer wing prevented the generation of the spanwise flow near its TE, thus avoiding the nose-up pitch departure. At α=12° and C_{π,0}>0.6, there is a strong spanwise flow in the crank region inboard of the first SJA (FIG. 8). It is most probably responsible for the nose-up pitch that is relatively weak for this high-power blowing that is much stronger than C_{π,0}=0.035 (the second curve in FIG. 5). This must have been exacerbated by the disappearance of the LEV from the outer wing due to the acceleration of the surface flow upstream of the SJA array. At α=14°, a separation focus is visible near the LE of the crank, and the surface spanwise flow, so prominently visible near the TE of the crank region at α=12°, disappeared. Both effects are associated with nose-down pitch (FIG. 5). At α=16°, the separation focus moved upstream of the MRP and became much larger, suggesting that the LEV on the inboard wing is stronger, thus resuming the nose-up pitch departure with increasing a (FIG. 6). The introduction of SSJs that do not entrain upstream fluid as effectively as the SJAs, resulted in more moderate nose-up and nose-down pitch departures (FIG. 5 right).

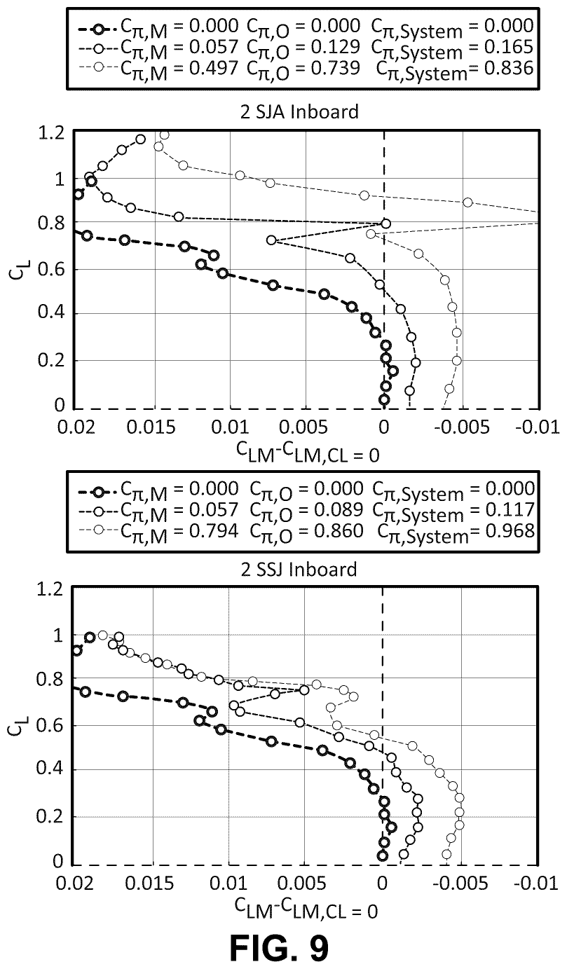

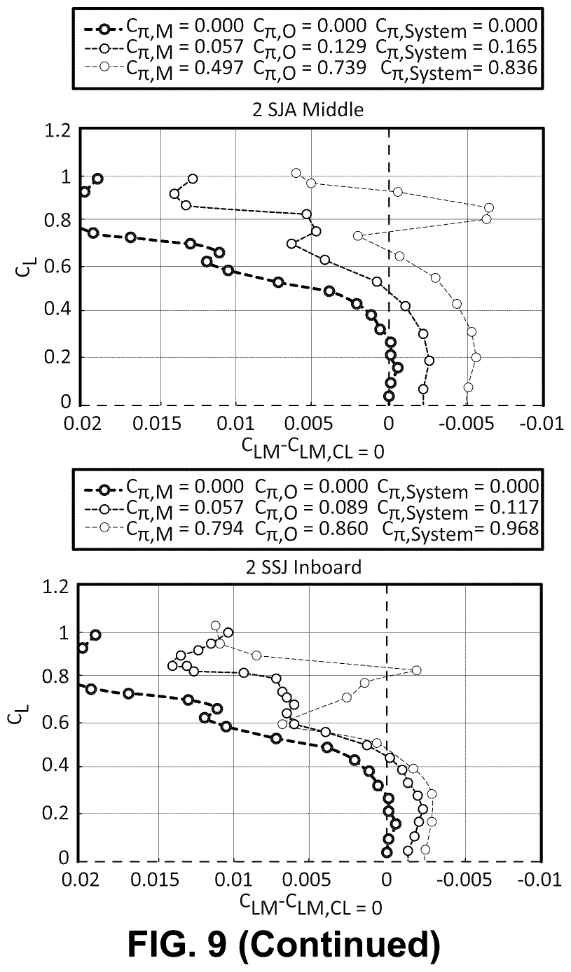

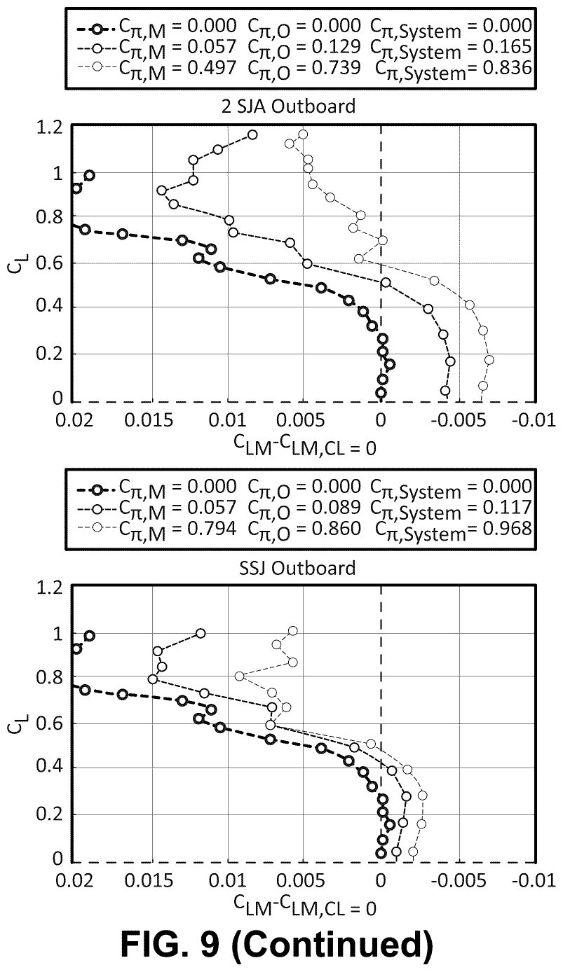

To check the hypotheses put forth by viewing the surface flow, the actuation was initially divided into three pairs of independently activated actuators at identical orientation but different locations along the span (FIG. 9). The plot reveals that the most inboard located pair of actuators are most effective, enabling trimmed C_{L}≈0.72 for the pair of SJAs having a total input of C_{π,0}=0.739. The same input directed toward the middle pair of actuators enabled trimmed flight up to C_{L}=0.65, and the outboard pair enabled trimming up to C_{L}=0.58 (FIG. 9 top). However, the actuation near the crank exhibited a very strong nose-down C_{LM} because it pulled outboard the LEV generated on the inner wing, while the same actuation near the tip did not result in any nose-down pitch with increasing incidence above C_{L}>0.75 (FIG. 9).

Similar trend was observed by using individual pairs of SSJs, except that their overall effect on C_{LM} was greatly reduced. For example, the most inboard pair of SSJs enabled trimmed conditions up to C_{L}=0.55 for the same mass flow used by the pair of SJAs that generated a C_{L}>0.7 (FIG. 9 bottom left). However, while the strong SJA input created a very large nose-down pitch departure around C_{L}=0.8 (FIG. 9 top left), the strong SSJ input effectively eliminated this trend (FIG. 9 bottom left). It suggests that the SSJ prevented the LEV coming from the inboard wing to proceed along the TE of the outboard wing. The middle and outboard pairs of actuators were even less effective and increasing the [symbol] by an order of magnitude (from 0.057 to 0.794) had hardly any effect on maintaining the aerodynamic center at higher C_{L} (FIG. 9 bottom center & right).

The use of SSJs in favor of SJAs might be favored, except for the fact that the main purpose for this test is to explore the potential use of AFC to replace conventional control surfaces. The control of yaw can be attained by applying actuation to a single wing and subtracting the baseline yaw, assuming that the model is symmetrical in the absence of actuation. In this case, the total power consumed by the actuators and by the system is of secondary importance because the duration of the application is short, and it can be augmented by local storage if needed. The difficult task is to obtain a large yawing moment with a small accompanying roll and a small interaction with pitch to enable a coordinated turn without gaining or losing altitude.

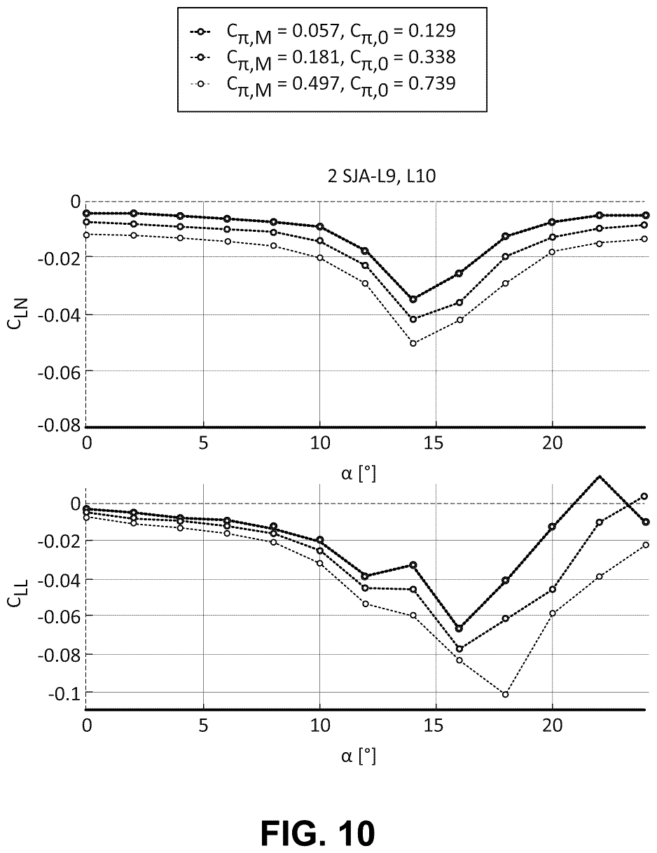

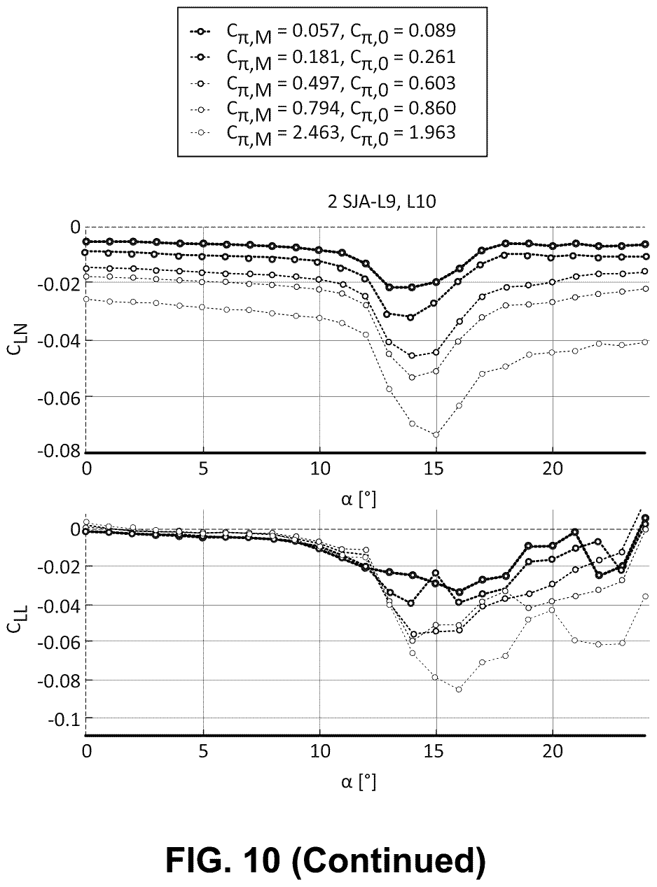

The C_{LN} obtained by using pairs of SJAs or pairs of SSJs is shown in FIG. 10. Note that in FIG. 10, the graphed lines are depicted in the same order top-to-bottom as the references are listed top-to-bottom in the legend. It is assumed that the yaw control authority is mostly needed during cruise and loiter because flaps and control surfaces can be used on takeoff and landing; therefore, limiting the incidence to 0°<α<12° corresponding to 0<C_{L}<0.6. The SSJs outperform the SJAs substantially, and hence the most inboard pair of SSJ's appears to be a good choice for this application as it also controls pitch the best (FIG. 9 bottom left). Its ΔC_{LN} approaches 0.04, and the ratio of ΔC_{LN}/ΔC_{LL}≈10. One may maintain the pitch at the prescribed level by lowering the input of another pair of actuators that are used for pitch control.

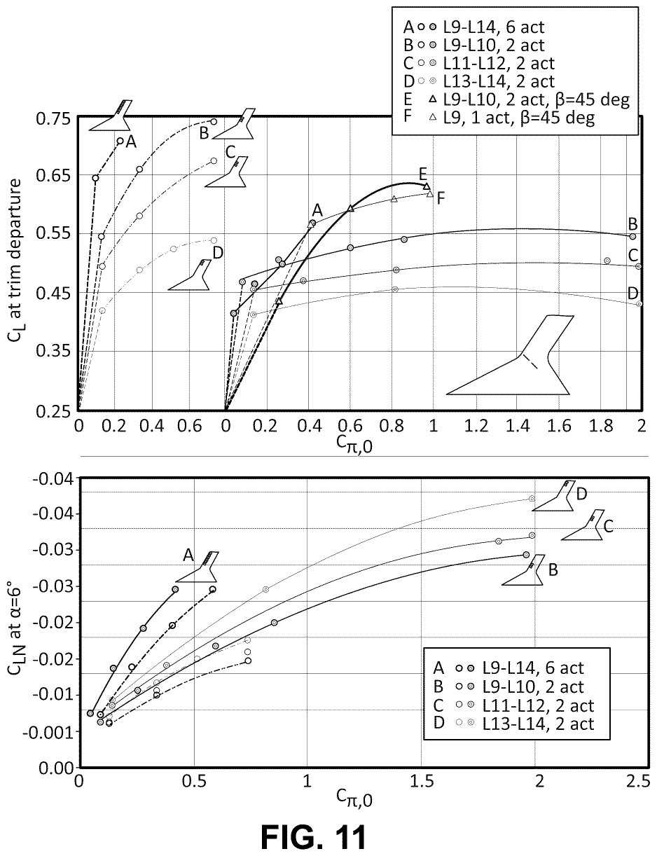

The AFC results that are focused on extending the longitudinal stability margin of the airplane model are summarized by plotting the maximum trimmed lift coefficient attained using SJAs and SSJs for various combinations of number and location of the actuators of identical size (nozzle 0.050″×0.080″). Since the direction of the flow emanating from an SSJ actuator depends on the actuator's orientation, the effect of orientation was briefly tested as well. The measurements were carried out by increasing the mass flow through the actuators and hence increasing C_{π,0}. The results are plotted in FIG. 11. Note that in the top portion of FIG. 11, the graphed lines with circle symbols are depicted in the same order top-to-bottom as the references are listed top-to-bottom in the legend.

Since the superiority of the SJAs in attaining larger maximum values of C_{L,trim} was already established, we shall focus on discussing potential optimization of the SSJs. When 6 SSJs were used covering approximately the entire outer wing surface, the maximum trimmed C_{L} increased almost linearly with increasing C_{π,0}, attaining C_{L,trim}=0.56 at C_{π,0}≈0.4, which is just slightly below the values that a mid-pair of SJAs (L11-L12) attained. However, the latter pair of SJAs could attain a C_{L,trim} of 0.67 by increasing C_{π,0} (FIG. 11 top). The increase in C_{L,trim} with increasing C_{π,0} when pairs of SSJs were used was minimal, and even the closest pair of SSJs near the crank (L9-L10) did not manage to exceed C_{L,trim}=0.55 when the jets emerged at β=90° (normal to LE). The performance of the other two pairs of SSJs (L11-L12 & L13-L14) was even poorer.

The orientation of the surface streamlines near the L9 actuator located closest to the crank revealed that the jet emanating from that actuator was almost parallel to those streamlines at the most critical incidence angles. Prior experiments on the MAGMA model suggested that the most effective use of a single SJA was when it was oriented perpendicular to the surface streamlines. Thus, a change in direction of the two most inboard SSJs was made. When these actuators turned inboard by 45° (β=45°), the effectiveness of the actuation increased substantially at C_{π,0}>0.5. The use of a single actuator at this p increased the C_{L,trim} to 0.65. This was comparable to the value obtained by 2 SJAs located somewhat further from the crank (FIG. 11 left). It is interesting to note that a single SSJ operating at C_{π,0}=0.4 generated an identical C_{L,trim} that 6 SSJs did (FIG. 11 top right). The efficacy of the same actuators in changing the flight direction by providing yawing moment, C_{LN}, is also demonstrated in FIG. 11 (bottom) for an assumed cruise condition at C_{L}≈0.3 corresponding to α=6°. In this case, the SSJs were superior providing larger C_{LN} for all locations and number of actuators considered.

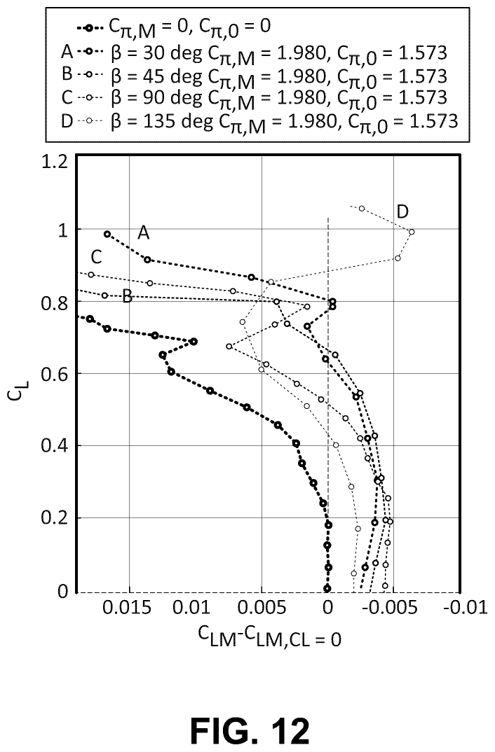

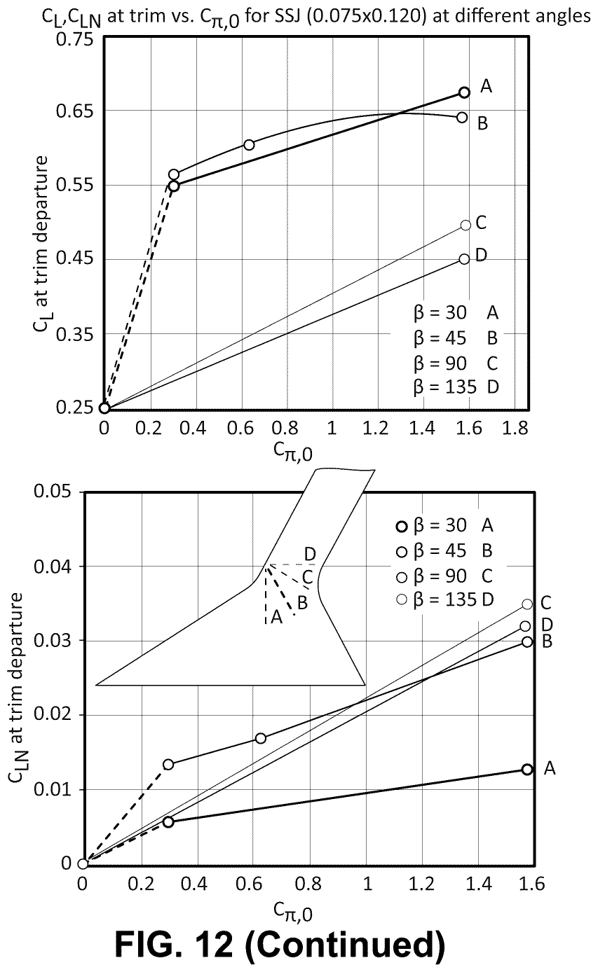

To investigate the effect of β on the effectiveness of an individual actuator while avoiding an increase in pressure for which the 3D printed parts were not designed, a larger SSJ was built where each of the two nozzle dimensions were increased by 50%, thus increasing the area by 225%. The pressure losses through this actuator were measured and plotted in FIGS. 3 and 4. Four wing inserts were built and tested using a single SSJ actuator oriented at 30° <β<135° relative to the LE, and the results are plotted in FIG. 12.

[symbol]

The sole parameter changed in FIG. 12 left was β, while C_{π,0} & [symbol] ) values were maintained constant. The least effective injection angle was β=135° where a [symbol] ≈2 prevented pitch-up to C_{L}=0.42 while creating a large nose down C_{LM} at C_{L}>0.8. Decreasing R to 90° could maintain the AC up to C_{L}=0.5 while reducing substantially the nose-down pitch excursion at higher C_{L}. This excursion was virtually eliminated at β=45° while the trimmed lift could be maintained up to C_{L}=0.68 at the prescribed [symbol] Increasing the orientation to β=60° improved the pitch control slightly but it created a nose-down deviation at slightly higher incidence. Thus, the orientation and location of a single SSJ may achieve all the goals set up by the AFC design. A few additional data points were taken at different values of [symbol] and they clearly demonstrated that actuation at β=45° performed best for the control of yaw (as shown in FIG. 12 right) and for pitch. Finally, a turning maneuver should be made in a coordinated fashion at a prescribed rate of turn, while having control over pitch and bank and maintaining altitude and speed. Therefore, the coupling between the forces and moments is analyzed first at altitude and then close to the ground to avoid disasters. The pitch can be controlled by a single SSJ on each wing located near the crank and operating at all times during cruise. Yaw can be provided by reducing the input to a single SSJ and/or by activating another SSJ located near the wing tip. The latter option can be more effective and easier to control as it is analogous to the conventional control surfaces of an airplane.

The addition of AFC to wing design involves many independent variables that are closely coupled to the conventional wing-design parameters. Thus, the role of AFC in the conceptual wing design process is determined from the start because different modes of actuation serve better for different applications, such as high lift generation, control of pitch, or maneuvering in lieu of conventional control surfaces. Multiple sources exist for the source of the power on which the actuators rely. Compressed air can be bled from the engine, or a dedicated compressor can be provided for each actuator or subset of actuators. With these parameters, the sizing, location, number, and orientation of the actuators can be determined, which may interact differently with conventional aerodynamic considerations, such as airfoil selection and wing planform that may include different segments separated by cranks (change of sweep and taper).

The current tests were used to demonstrate the richness of the parameter space involved on the AFC design side, although the wing design was frozen. The tests show that even a single small supersonic steady jet that is located and oriented properly on the wing can have sufficient control authority to replace conventional control surfaces and to replace an array of SJAs. The jet area relative to the plane's planform area is of the order of 10⁻⁵ such that AFC may replace some complex control surfaces very effectively.

As shown in FIG. 1, sweeping jet actuators (SJAs) were installed in an upper surface of an aircraft wing along the leading and trailing edges of the wing and tested. Those SJAs were partially replaced with SSJs, which were tested independently and which provided better results compared to the SJAs. In the example of FIG. 1, thirty-one SJAs are installed. The leading edge SJAs are numbered L1-L14. The trailing edge SJAs are numbered T1-T17. These SJAs were partially replaced by SSJs in certain tests, providing better results. The aircraft depicted in FIG. 1 is a tailless (without an empennage, vertical stabilizer, and horizontal stabilizer) blended-wing-body (“BWB”) configuration. The BWB configuration includes an inner wing section and an outer wing section connected at the leading edge and trailing edge cranks between L8-L9 and T6-T7, respectively. The invention is applicable to control of any suitable aircraft configuration using SJAs or SSJs as described herein. For example, the aircraft is not limited to a tailless aircraft. The aircraft may comprise one or more of an empennage, a vertical stabilizer, or a horizontal stabilizer, and may be a conventional “tube and wing” design. Additionally, the aircraft may be any suitable type of aircraft, such as a piloted aircraft or unmanned aerial vehicles (e.g., drones), large or small in size, or any other suitable aircraft.

Any suitable SSJ may be utilized. While thirty-one SJAs are depicted in FIG. 1 and were partially replaced with SSJs, any number of SSJs may be utilized to provide the desired control. For example, fewer SSJs located at certain positions on the wing and orientated to expel their jets in a specified direction may be suitable, as described herein. In some cases, a single SSJ, or a pair of SSJs may provide the desired control. Any number of SSJs from one to thirty-one or more may be utilized, as desired. Additionally, SSJs may be provided on the leading edge, the trailing edge, or both, depending on the type (roll, pitch, yaw) and amount of control desired. Fewer SSJs can provide better control than arrays of SJAs. Thus, if desired, the SSJs may be spaced farther apart than conventional SJAs, grouped together and provided with space between the groups (for example, groups of two, three, four, or more SSJs may be provided), or provided individually at desired locations. Additionally, multiple SSJs may be provided on a wing, and a flight control system controls activation of all or a subset of the SSJs. In this manner, a group of one, two, three, or more SSJs may be activated individually or in tandem with another group of one, two, three, or more SSJs to provide a desired amount of control for the aircraft to which the wing is attached. The direction (e.g., angle) of the jet emanating from each SSJ also can be directed in selected directions to provide the desired amount of control for the aircraft. The locations of the activated SSJs and the jet output angle for each respective SSJ is selected based on various factors, such as angle of attack of the wing, control inputs received, local flow conditions over the wing, and/or any other suitable factors.

The SSJs discussed herein were designed to provide a nominal fluid (e.g., air or other suitable fluid) output of Mach 1.5 under ideal conditions. As with the number of SSJs, the output of the SSJs may be configured to any suitable output to provide the desired amount of control. Additionally, the output of the SSJs may be dynamically controlled to provide a range of outputs based on the flight conditions and the desired amount of control.

FIG. 11 details the performance of SSJs L9-L14, or smaller combinations of those SSJs compared to the same number of SJAs. In each case, the SSJs outperformed the SJAs substantially. Focusing on the orientation of the SSJs, FIG. 11 depicts results for SSJs providing an output (i.e., the jet emanating from an SSJ) in a direction that is normal to the leading edge of the wing (β=90 degrees). In this case, the SSJ output is almost parallel to the streamlines of air over the wing. The orientation of the SSJs can be modified to direct the SSJ output to angle with respect to the leading edge and/or the streamlines over the wing. For example, FIG. 11 also depicts improved results for SSJs providing an output in a direction that is angled with respect to the leading edge of the wing (β=45 degrees). Additionally, in certain cases, fewer angled SSJs (i.e., 1 or 2 SSJs) provided better results than a larger number of SSJs operating in the same conditions (i.e., 6 SSJs). Orientation of the SSJ output with regard to the leading edge and/or the streamlines of air flowing over the wing provides significant improvement to the coefficient of lift.

FIG. 12 depicts the effect of SSJ orientation on the control of pitch and yaw. For the test results of FIG. 12, a single SSJ was oriented at various angles from 30°<β<135° relative to the leading edge of the wing. The results show that the orientation and location of a single SSJ may achieve all the goals set up by the particular AFC design. Actuation of SSJs at β=45° performed best for the control of yaw (as shown in the right side of FIG. 12) and for pitch. Thus, even a single, small SSJ that is located and oriented properly on the wing can have sufficient control authority to replace conventional control surfaces.

Improved results were achieved by angling the SSJ output with respect to the leading edge of the wing and thus with the slipstream of air over the wing. If the slipstream is not normal to the leading edge of the wing, the SSJ can be angled more or less to compensate for the angle between the slipstream and the leading edge.

SSJs described herein may be installed in a wing in any suitable manner. For example, the nozzle for an SSJ may be coupled to the surface of a wing, or the nozzle for an SSJ may be recessed in the surface of the wing to reduce drag. In either case, the nozzle can be coupled to the wing in any suitable manner, such as by welding or mechanical connection, such as a nut/bolt type system, rivets, or other suitable connection.

Other components of the SSJ are installed inside the aircraft, for example, inside the wing, fuselage, or other aircraft structure. Multiple sources exist for the source of the power on which the actuators rely. Compressed air can be bled from the engine, or a dedicated compressor can be provided for each actuator or subset of actuators. Supply lines, power, processors/controllers, plenums, compressors, and any other components can be mounted to the aircraft in any suitable manner, such as by welding or with suitable fasteners, such as bolts, rivets, brackets, etc., with the corresponding nozzle positioned to dispense its output along the exterior surface of the wing in a desired direction relative to the leading edge of the wing or the airflow over the wing.

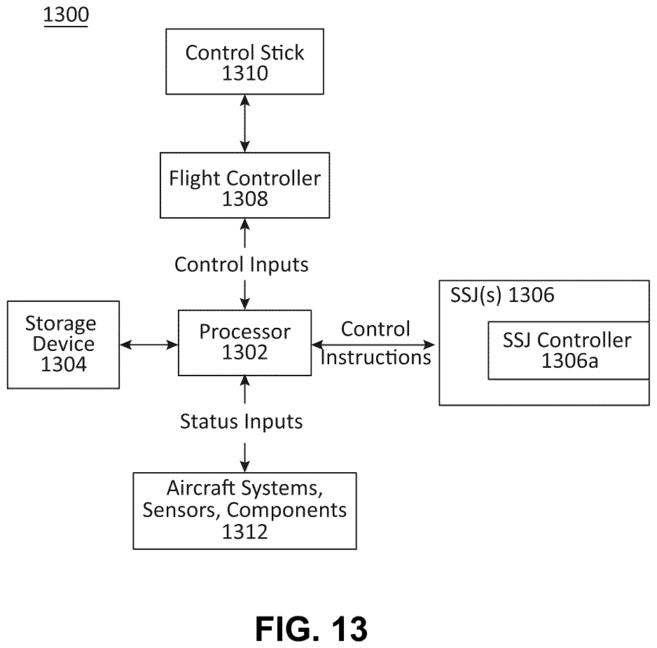

FIG. 13 is a block diagram depicting an aircraft flight control system 1300 to control forces and moments on aircraft. The flight control system 1300 comprises a storage device 1304, a processor 1302 communicatively coupled to the storage device 1304, and one or more SSJs 1306 coupled to the processor 1302. The processor 1302 executes application code instructions that are stored in the storage device 1304 to cause the system 1300 to control moments and forces on aircraft. For example, the processor 1302 receives control inputs for flight attitude(s) from a peripheral device, such as a flight controller 1308 coupled to an input device (for example, a control stick 1310 in the aircraft or at a control station controlling the aircraft). The flight controller 1308 inputs indicate a desired force in pitch, roll, and/or yaw, or change therein, for the aircraft. The processor 1302 also receives status inputs from other aircraft systems, sensors, or components 1312 indicating airspeed, angle of attack, altitude, bank angle, local airflow over the wing, or other suitable inputs. The processor 1302 determines, based on the control inputs and the status inputs, an amount of SSJ activation to execute the desired flight attitude and communicates instructions to one more SSJs 1306 to activate for a specified time, in a specified direction, and with a specified thrust. At each instructed SSJ 1306, an SSJ controller 1306a receives the instructions, controls the SSJ 1306 to turn its thrust in the specified direction based on the received instructions, and activates the SSJ 1306 for the specified time and with the specified thrust based on the received instructions.

In certain examples, the SSJs 1306 may have a fixed orientation. In this case, the processor 1302 determines, based on the control inputs and the status inputs, an amount of SSJ activation to execute the desired flight attitude and communicates instructions to one more SSJs 1306 to activate for a specified time and with a specified thrust. At each instructed SSJ 1306, the SSJ controller 1306a receives the instructions, and activates the SSJ 1306 for the specified time and with the specified thrust based on the received instructions.

In certain examples, the SSJs 1306 may also have a fixed thrust output. In this case, the processor 1302 determines, based on the control inputs and the status inputs, an amount of SSJ activation to execute the desired flight attitude and communicates instructions to one more SSJs 1306 to activate for a specified time. At each instructed SSJ 1306, the SSJ controller 1306a receives the instructions, and activates the SSJ 1306 for the specified time to output the fixed thrust based on the received instructions.

Each SSJ 1306 may have an individual controller 1306a, or one or more controllers 1306a may control multiple SSJs 1306. In this manner, the processor 1302 determines one or more forces and/or moments needed to provide the desired flight attitude, based on the control inputs and the status inputs, and communicates instructions to the SSJs 1306 to activate to provide the determined forces and/or moments to the aircraft. In response, the SSJs execute the received instructions and activate accordingly to provide the determined forces and/or moments to the aircraft.

The processer 1302 determines, based on the control inputs and the status inputs, the number and location of SSJs 1306 to activate. As described herein, SSJs 1306 that are activated can provide more or less moment or force based on the location of the activated SSJ 1306 on the wing. In this manner, based on the desired amount of control, the processor 1302 may determine to active one or multiple SSJs 1306. Activation of various amounts and locations of SSJs 1306 has been described previously herein.

The processor 1302 also can control conventional aircraft control surfaces, such as rudder, elevator, and ailerons, or other surfaces, to control the aircraft based on the control inputs and the status inputs.

All components of the flight control system may be installed in an aircraft. Alternatively, certain components may be installed in the aircraft, while other components are located remote to the aircraft, with communications between the components occurring over a network. For example, the SSJs 1306 and the aircraft systems, sensors, and components may be installed on the aircraft, and the remaining components may be located remote to the aircraft.

Although being described herein as being disposed on an upper surface of the wing, the SSJs may be disposed on any suitable location on the wing, such as a lower surface or edges (if applicable) of the wing.

### Other Example Embodiments

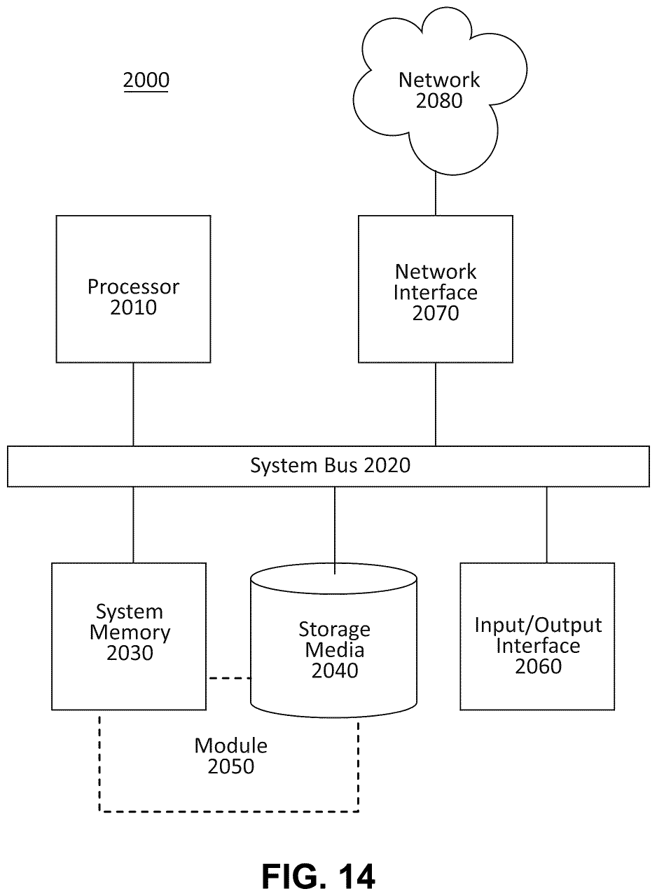

FIG. 14 depicts a computing machine 2000 and a module 2050 in accordance with certain example embodiments. The computing machine 2000 may correspond to any of the various computers, controllers, processors, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touchscreens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain example embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

### General Disclosures

While embodiments of this disclosure are described in connection with examples and the corresponding text and figures, there is no intent to limit embodiments of this disclosure to this description. On the contrary, the intent is to cover all alternatives, modifications, and equivalents included within the spirit and scope of embodiments of this disclosure. The examples described herein are put forth so as to provide those of ordinary skill in the art with a complete disclosure and description of how to make and use the invention claimed herein. Efforts have been made to ensure accuracy with respect to numbers (e.g., amounts, temperature, etc.), but some errors and deviations should be accounted for.

It is to be understood that this disclosure is not limited to the particular embodiments described, and as such may, of course, vary. It is also to be understood that the terminology used herein is for the purpose of describing particular embodiments only and is not intended to be limiting.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of this disclosure, certain methods and materials are now described.

All publications and patents cited in this specification are cited to disclose and describe the methods and/or materials in connection with which the publications are cited. The complete disclosure of all such publications and patents are herein incorporated by references as if each individual publication or patent was specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in this application should not be treated as such and should not be read as defining any terms appearing in the accompanying claims. The citation of any publication is for its disclosure prior to the filing date and should not be construed as an admission that this disclosure is not entitled to antedate such publication by virtue of prior disclosure. Further, the dates of publication provided could be different from the actual publication dates that may need to be independently confirmed.

As will be apparent to those of ordinary skill in the art upon reading this disclosure, each of the individual embodiments described and illustrated herein has discrete components and features which may be readily separated from or combined with the features of any of the other described embodiments without departing from the scope or spirit of this disclosure. Any recited method can be carried out in the order of events recited or in any other order that is logically possible.

Where a range is expressed, a further aspect includes from the one particular value and/or to the other particular value. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, amounts, and other numerical data can be expressed herein in a range format. It will be further understood that the endpoints of each of the ranges are significant both in relation to the other endpoint, and independently of the other endpoint. It is also understood that a number of values are disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range, as if each numerical value and sub-range is explicitly recited. To illustrate, a numerical range of “about 30 to 135” should be interpreted to include not only the explicitly recited values of about 30 to about 135, but also include individual values (e.g., about 30, about 31, about 32, etc.) and the sub-ranges (e.g., about 30 to about 45, about 60 to about 70, etc. and other possible sub-ranges) within the indicated range.

As used herein, the singular forms “a,” “an,” and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by, e.g., a given data set, art accepted standard, and/or with, e.g., a given confidence interval (e.g., 90%, 95%, or more confidence interval from the mean), such as variations of +/−10% or less, +/−5% or less, +/−1% or less, and +/−0.1% or less of and from the specified value, insofar such variations are appropriate to perform in the disclosed invention. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of ordinary skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance, or substituent may or may not occur, and that the description includes instances where the event or circumstance occurs and instances where it does not.

The recitation of numerical ranges by endpoints includes all numbers and fractions subsumed within the respective ranges, as well as the recited endpoints.

Various embodiments are described herein. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment,” “an embodiment,” “an example embodiment,” means that a particular feature, structure, or characteristic described in connection with the embodiment is included in at least one embodiment of the invention described herein. Thus, appearances of the phrases “in one embodiment,” “in an embodiment,” or “an example embodiment” in various places throughout this specification are not necessarily all referring to the same embodiment, but may. Furthermore, the particular features, structures, or characteristics may be combined in any suitable manner, as would be apparent to a person having ordinary skill in the art from this disclosure, in one or more embodiments. Additionally, while some embodiments described herein include some but not other features included in other embodiments, combinations of features of different embodiments are meant to be within the scope of the invention. For example, in the appended claims, any of the claimed embodiments can be used in any combination.

The complete disclosure of all publications, published patent documents, and patent applications cited herein is hereby fully incorporated by reference to the same extent as though each individual publication, published patent document, or patent application was specifically and individually indicated as being incorporated by reference.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Various modifications and variations of the inventions described herein will be apparent to those having ordinary skill in the art without departing from the scope and spirit of the invention. Although the invention has been described in connection with specific embodiments, it will be understood that it is capable of further modifications and that the invention as claimed should not be unduly limited to such specific embodiments. Indeed, various modifications of the described modes for carrying out the invention that are obvious to those having ordinary skill in the art are intended to be within the scope of the invention. This application is intended to cover any variations, uses, or adaptations of the invention following, in general, the principles of the invention and including such departures from this disclosure that come within known customary practice within the art to which the invention pertains and may be applied to the essential features herein before described.

1. A system to control moments and forces on aircraft, comprising:
a wing comprising a leading edge; and
at least one supersonic steady jet (SSJ) disposed on an upper surface of the wing, the SSJ being oriented such that a jet output from the SSJ is angled with respect to the leading edge of the wing.

2. The system of claim 1, wherein the jet output from the SSJ is angled within a range of about 0 degrees to 360 degrees with respect to the leading edge of the wing.

3. The system of claim 1, wherein the jet output from the SSJ is angled within a range of about 0 degrees to about 180 degrees with respect to the leading edge of the wing.

4. The system of claim 1, wherein the jet output from the SSJ is angled within a range of about 20 degrees to about 160 degrees with respect to the leading edge of the wing.

5. The system of claim 1, wherein the jet output from the SSJ is angled within a range of about 30 degrees to about 135 degrees with respect to the leading edge of the wing.

6. The system of claim 1, wherein the jet output from the SSJ is angled 45 degrees with respect to the leading edge of the wing.

7. The system of claim 1, wherein the jet output from the SSJ is angled 45 degrees with respect to the leading edge of the wing on an inboard side of the wing.

8. The system of claim 1, wherein the jet output from the SSJ is angled 45 degrees with respect to the leading edge of the wing on an outboard side of the wing.

9. The system of claim 1, wherein the at least one SSJ comprises a single SSJ.

10. The system of claim 1, wherein the at least one SSJ comprises a plurality of SSJs.

11. The system of claim 1, wherein the at least one SSJ comprises a plurality of SSJs that are activatable individually or in groups of two or more.

12. The system of claim 1, wherein the at least one SSJ comprises a plurality of SSJs, and wherein less than all of the SSJs are activated at the same time.

13. The system of claim 1, wherein the at least one SSJ comprises a plurality of SSJs, and only one of the SSJs is activated at a time.

14. The system of claim 1, wherein the at least one SSJ comprises a plurality of SSJs, and a different one or more of the SSJs is activated to provide a desired control depending on an attitude of the aircraft to which the wing is attached.

15. The system of claim 1, further comprising the aircraft to which the wing is attached.

16. The system of claim 15, wherein the aircraft is a tailless aircraft.

17. The system of claim 15, wherein the aircraft comprises an empennage.

18. The system of claim 15, wherein the aircraft comprises at least one of a vertical stabilizer and a horizontal stabilizer.

19. A system to control moments and forces on aircraft, comprising:
a wing comprising a leading edge, the wing having streamlines of airflow over the wing when moving through the air; and
at least one supersonic steady jet (SSJ) disposed on an upper surface of the wing, the SSJ being oriented such that a jet output from the SSJ is angled with respect to the streamlines of airflow over the wing.

20. (canceled)

21. (canceled)

22. (canceled)

23. (canceled)

24. (canceled)

25. (canceled)

26. (canceled)

27. (canceled)

28. (canceled)

29. The system of claim 19, wherein the at least one SSJ comprises a plurality of SSJs that are activatable individually or in groups of two or more.

30. (canceled)

31. (canceled)

32. The system of claim 19, wherein the at least one SSJ comprises a plurality of SSJs, and a different one or more of the SSJs is activated to provide a desired control depending on an attitude of the aircraft to which the wing is attached.

33. (canceled)

34. (canceled)

35. (canceled)

36. (canceled)

37. A system to control moments and forces on aircraft, comprising:
a wing comprising a leading edge and a tip;
at least one yaw-control supersonic steady jet (SSJ) disposed along the leading edge of the wing near the tip of the wing, activation of the yaw-control SSJ providing a yaw moment to an aircraft to which the wing is attached; and
at least one pitch-control SSJ disposed along the leading edge of the wing at an inner position on the wing compared to the location of the yaw-control SSJ, activation of the pitch-control SSJ providing a pitching moment to the aircraft to which the wing is attached.

38. (canceled)

39. A method to control moments and forces on aircraft, comprising:
providing a wing comprising a leading edge;
providing at least one supersonic steady jet (SSJ) disposed on an upper surface of the wing, the SSJ being oriented such that a jet output from the SSJ is angled with respect to the leading edge of the wing; and
expelling a jet of air from the SSJ.

40. (canceled)

41. (canceled)

42. (canceled)

43. (canceled)

44. (canceled)

45. (canceled)

46. (canceled)

47. (canceled)

48. (canceled)

49. (canceled)

50. A system to control moments and forces on aircraft, comprising:
at least one at least one supersonic steady jet (SSJ) disposed on an upper surface of a wing;
a storage device; and
a processor communicatively coupled to the storage device, wherein the processor executes application code instructions that are stored in the storage device to cause the system to:
receive control inputs for a flight attitude from a peripheral device, the control inputs indicating a desired force in pitch, roll, and/or yaw, or change therein, for the aircraft;
receive status inputs from aircraft systems, sensors, or components indicating airspeed, angle of attack, altitude, bank angle, local airflow over the wing, or other suitable inputs;
determine, based on the control inputs and the status inputs, an amount of SSJ activation to execute the desired flight attitude; and
communicate instructions to one more SSJs to activate for a specified time, in a specified direction, and with a specified thrust to achieve the desired flight attitude.

51. (canceled)

52. The system of claim 50, wherein for each instructed SSJ, an SSJ controller receives the instructions, controls the SSJ to turn its thrust in the specified direction, and activates the SSJ for the specified time and with the specified thrust.
